(19) United States
(12) Patent Application Publication
(10) Pub. No.: US 2019/0016935 A1
(43) Pub. Date: Jan. 17, 2019

(54) SILICONE-BASED ADHESIVE COMPOSITIONS AND ADHESIVE ARTICLES

(71) Applicant: 3M INNOVATIVE PROPERTIES COMPANY, St. Paul, MN (US)

(72) Inventors: DAVID S. HAYS, WOODBURY, MN (US); RICHARD G. HANSEN, MAHTOMEDI, MN (US); JAMES P. DiZIO, ST. PAUL, MN (US); DANIEL A. LUEDTKE, DETROIT, MI (US); JOAN M. NOYOLA, MAPLEWOOD, MN (US); SCOTT M. TAPIO, FALCON HEIGHTS, MN (US)

(21) Appl. No.: 16/066,786

(22) PCT Filed: Dec. 22, 2016
(86) PCT No.: PCT/US2016/068181

§ 371 Date: Jun. 28, 2018

Related U.S. Application Data
(60) Provisional application No. 62/273,623, filed on Dec. 31, 2015.

(51) Int. Cl. C09J 183/08; C09J 7/38; C09J 7/26

(52) U.S. Cl. CPC C09J 183/08; C09J 7/38; C09J 7/26; C09J 2400/143; C09J 2475/00; C09J 2479/00; C09J 2483/00; C09J 2205/114

(57) ABSTRACT

Adhesive composition including an elastomeric silicone-based copolymer selected from the group consisting of urea-based silicone copolymers, oxamide-based silicone copolymers, amide-based silicone copolymers, urethane-based silicone copolymers and mixtures thereof; and greater than 0% by weight and no more than 20% by weight of MQ resin. In certain embodiments, the adhesive compositions includes less than 10% by weight of MQ resin. In some illustrative embodiments, the adhesive composition is a pressure-sensitive adhesive. In certain illustrative embodiments, the pressure sensitive adhesive is optically clear, self-wetting to the end-use substrate, and stretch releasable. In certain such embodiments, the adhesive article exhibits a 180° PEEL ADHESION to a glass substrate no greater than about 500 N/dm after aging for seven days at 85° C. The pressure sensitive adhesive compositions may be used to form adhesive articles and adhesive assemblies.

### TECHNICAL FIELD

The present disclosure relates to silicone-based adhesive compositions, and adhesive articles including the silicone-based adhesive compositions.

### BACKGROUND

Pressure-sensitive adhesive compositions are very versatile because they tend to adhere to a variety of end-use substrates. Many pressure-sensitive adhesive compositions are coated onto a release liner as a wet composition, dried and wound up into a roll. Release liners provide a variety of functions for pressure-sensitive adhesive compositions including, e.g., preventing contamination of the adhesive layer, facilitating handling of the adhesive or an adhesive-coated article (e.g., by providing support thereto as well as covering the adhesive), identifying articles on which the release liner is disposed, and combinations thereof. Providing the pressure-sensitive adhesive composition on a release liner also facilitates further processing of the adhesive, including, e.g., transfer laminating, converting and packaging.

Pressure-sensitive adhesive tapes that are removable from an end-use substrate, e.g. by stretching the adhesive tape, are often referred to as stretch releasing adhesive tapes. Stretch releasing adhesive tapes are often used to temporarily bond a film to a substrate, and subsequently release the film from the substrate when desired by stretching the adhesive tape. Stretch releasing adhesive tapes are useful in a variety of applications including, e.g., assembling, joining, attaching and mounting applications. Ideally, the stretch releasing adhesive tapes, once bonded to a substrate, e.g., wallboard, are cleanly removable from the substrate such that there is no visible adhesive residue remaining on the substrate and no visible damage to the substrate.

Some highly tackified silicone-based pressure-sensitive adhesive compositions are known to be useful in making stretch releasing adhesive tapes. One such commercially-available stretch releasing adhesive tape is sold under the trade designation COMMAND® by 3M Company, St. Paul, Minn.

### SUMMARY

Briefly, in one aspect, the disclosure describes an adhesive composition including an elastomeric silicone-based copolymer selected from the group consisting of urea-based silicone copolymers, oxamide-based silicone copolymers, amide-based silicone copolymers, urethane-based silicone copolymers, and mixtures thereof; and greater than 0% by weight and no more than 20% by weight of MQ resin. In certain presently preferred embodiments, the adhesive composition includes less than 10% by weight of MQ resin.

In some illustrative embodiments, the adhesive composition is a pressure-sensitive adhesive. In certain illustrative embodiments, the pressure sensitive adhesive is optically clear. In further illustrative embodiments, the pressure sensitive adhesive is applied to at least one major surface of a substrate.

In another aspect, the disclosure describes an adhesive article wherein the adhesive is a pressure-sensitive adhesive on a surface of a substrate. In certain embodiments, the pressure sensitive adhesive comprises a single layer on at least one major surface of the substrate. In some such embodiments, the substrate is selected from a rigid surface, a tape backing, a film, a sheet, or a release liner. In other embodiments, the substrate is selected from glass, ceramic, polymeric, metal, wood, or combinations thereof. In certain such embodiments, the substrate is selected from a polymeric film, an optical film, or a release liner. In further such embodiments, the pressure-sensitive adhesive comprises at least one structured surface. In additional illustrative embodiments, the adhesive article further comprises at least one layer comprising a foam.

In yet another aspect, the disclosure describes an adhesive assembly including a first substrate, a second substrate, and a pressure-sensitive adhesive disposed between the first substrate and the second substrate, wherein the pressure-sensitive adhesive includes any of the foregoing pressure-sensitive adhesive compositions. In certain illustrative embodiments, the first substrate and the second substrate are a rigid surface, a tape backing, a film, a sheet, or a release liner. In some such embodiments, the first substrate is a polymeric film selected from a fluorothermoplastic film, a polyester film, a polyamide film, a poly(meth)acrylate film, a polyolefin film, or a polycarbonate film. In other illustrative embodiments, the second substrate is a rigid substrate selected from glass, ceramic, porcelain, polymer, metal, or wood. In additional illustrative embodiments, the second substrate is a window, a vehicle windshield, or an electronic display device. In certain such embodiments, the second substrate comprises an electronic display device selected from a television, a computer monitor, a cellular phone display, a laptop computer display, a notebook computer display, or a tablet computer display, and further wherein the pressure-sensitive adhesive is optically clear and stretch releasable.

In another aspect, the present disclosure describes optically clear, stretch releasable adhesive tapes or films, articles that contain the adhesive tapes or films, and uses of the adhesive tapes or films. The adhesive tapes or films can be used to couple two substrates together. In certain such embodiments, the adhesive tapes or films can be used to optically couple the two substrates together. In many such applications, the second substrate can be viewed by looking through both the first substrate and the optically clear, stretch releasable adhesive tape or film.

In some such embodiments, the optically clear adhesive tape or film is stretch releasing. That is, the adhesive tape or film can be released from at least the second substrate by stretching the adhesive tape or film. Releasing the adhesive tape or film allows the two substrates to be easily separated (i.e., decoupled), without leaving behind substantial adhesive residues on at least one of the substrates, more preferably the second substrate. This allows the second substrate to be used again if the coupling is defective. This is particularly advantageous if the second substrate is expensive, fragile, or difficult to manufacture.

Various unexpected results and advantages are obtained in the various illustrative embodiments of the present disclosure. In certain illustrative embodiments, the adhesive article is optically clear, and preferably has a visible light transmission of at least about 90%, and a haze of no greater than 5%. In further such embodiments, the adhesive of the adhesive article is self-wetting to the end-use substrate. In additional such embodiments, the adhesive article is extensible, and is stretch releasable. In certain presently-preferred embodiments, the adhesive article exhibits a 180° PEEL ADHESION to a glass substrate no greater than about 500 N/dm after aging for seven days at 85° C.

Various aspects and advantages of illustrative embodiments of the present disclosure have been summarized. These aspects and advantages and others are within the scope of the following listing of illustrative embodiments.

### Listing of Illustrative Embodiments

A. An adhesive composition comprising:

an elastomeric silicone-based copolymer selected from the group consisting of urea-based silicone copolymers, oxamide-based silicone copolymers, amide-based silicone copolymers, urethane-based silicone copolymers, and mixtures thereof; and

greater than 0% by weight and no more than 20% by weight of MQ resin.
B. The adhesive composition of embodiment A, comprising less than 10% by weight of MQ resin.
C. The adhesive composition of embodiment A or B, wherein the elastomeric silicone-based copolymer comprises a urea-based silicone copolymer which is the reaction product of a polydiorganosiloxane diamine having a molecular weight of at least 5,000 grams/mole, and a polyisocyanate.
D. The adhesive composition of embodiment A or B, wherein the elastomeric silicone-based copolymer comprises a urea-based silicone copolymer which is the reaction product of a polydiorganosiloxane diamine having a molecular weight of at least 5,000 g/mole, a polyamine, and a polyisocyanate.
E. The adhesive composition of embodiment D, wherein the polyamine has a molecular weight no greater than about 300 g/mole.
F. The adhesive composition of any one of embodiments C-E, wherein the polydiorganosiloxane diamine has a molecular weight of from about 10,000 g/mole to about 65,000 g/mole.
G. The adhesive composition of any one of embodiments C-F, wherein the urea-based silicone copolymer is a silicone polyurea block copolymer comprising:
n blocks represented by the formula:

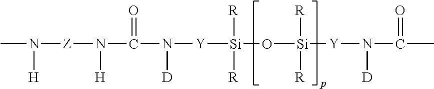

and m blocks represented by the formula:

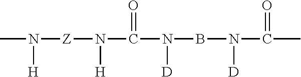

wherein

each R independently represents a monovalent group selected from the group consisting of alkyl groups, vinyl groups, higher alkenyl groups, cycloalkyl groups, aryl groups, and fluorine-containing groups;

each Z independently represents a divalent group selected from the group consisting of arylene groups, alkarylene groups, aralkylene groups, alkylene groups, and cycloalkylene groups, and combinations thereof.

each Y independently represents a divalent group selected from the group consisting of alkylene groups, alkarylene groups, aralkylene groups, arylene groups, and combinations thereof.

each D is independently selected from the group consisting of hydrogen, alkyl groups having 1 to 10 carbon atoms, phenyl, and groups that complete a ring structure including B or Y to form a heterocycle;

each B independently represents a divalent group selected from the group consisting of alkylene groups, alkarylene groups, aralkylene groups, cycloalkylene groups, arylene groups, and poly(alkyleneoxy) groups, and combinations thereof;

p is an integer number that is at least 10;

n is an integer that is at least 1; and

m is an integer in a range of from at least 1 up to and including 1,000, and wherein the ratio of n to m is in a range of from about 1:10 to about 10:1.
H. The adhesive composition of embodiment G, wherein

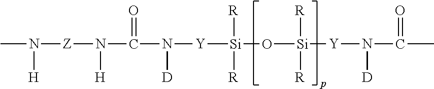

has a formula weight of 10,000 to about 40,000 grams per mole.
I. The adhesive composition of embodiment G or H, wherein R is methyl, Z is —CH₂C₆H₄C(CH₃)₂C₆H₄CH₂—, Y is —CH₂CH₂CH₂—, D is H, and B is —CH₂CH₂CH₂CH(CH₃)—.
J. The adhesive composition of any one of embodiments G-I, wherein the ratio of n to m is about one.
K. The adhesive composition of any one of embodiments G-J, wherein the silicone polyurea block copolymer comprises the reaction product of a polydiorganosiloxane diamine having a weight average molecular weight of from about 10,000 g/mole to about 65,000 g/mole, no greater than 3 moles of polyamine, and a polyisocyanate.
L. The adhesive composition of embodiment A or B, wherein the elastomeric silicone-based copolymer comprises an amide-based silicone copolymer comprising at least two repeat units of the formula:

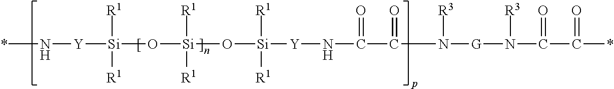

wherein each R¹ is independently an alkyl, haloalkyl, aralkyl, alkenyl, aryl, or aryl substituted with an alkyl, alkoxy, or halo;

each Y is independently an alkylene, aralkylene, or a combination thereof;

G is a divalent residue equal to a diamine of formula R³HN-G-NHR³ minus the two —NHR³ groups;

R³ is hydrogen or alkyl or R³ taken together with G and to the nitrogen to which they are both attached form a heterocyclic group;

n is independently an integer of 0 to 1500; and

p is an integer of 1 to 10.
M. The adhesive composition of any preceding embodiment, wherein the adhesive composition is a pressure-sensitive adhesive.
N. The adhesive composition of embodiment M, wherein the pressure sensitive adhesive is optically clear.
O. An adhesive article comprising the pressure sensitive adhesive of any one of embodiments A-N, applied to at least one major surface of a substrate.
P. The adhesive article of embodiment O, wherein the pressure sensitive adhesive comprises a single layer on at least one major surface of the substrate.
Q. The adhesive article of any one of embodiments O or P, wherein the substrate comprises a rigid surface, a tape backing, a film, a sheet, or a release liner.
R. The adhesive article of any one of embodiments O-Q, wherein the substrate is selected from glass, ceramic, polymeric, metal, wood, or combinations thereof.
S. The adhesive article of embodiment R, wherein the substrate is selected from a polymeric film, an optical film, or a release liner.
T. The adhesive article of any one of embodiments O-S, wherein the adhesive article has a visible light transmission of at least about 90%, and a haze of no greater than 5%.
U. The adhesive article of any one of embodiments O-T, wherein the adhesive article is extensible, and is stretch releasable.
V. The adhesive article of embodiment U, further comprising additional extensible layers.
W. The adhesive article of any one of embodiments O-V, wherein the pressure-sensitive adhesive layer has a thickness from about 25 micrometers to about 300 micrometers
X. The adhesive article of any one of embodiments O-W, wherein the pressure-sensitive adhesive comprises at least one structured surface.
Y. The adhesive article of any one of embodiments O-X, wherein the adhesive article further comprises at least one layer comprising a foam.
Z. The adhesive article of any one of embodiments O-Y, wherein the adhesive article exhibits a 180° PEEL ADHESION to a glass substrate no greater than about 500 N/dm after aging for seven days at 85° C.
AA. An adhesive assembly comprising:

a first substrate;

a second substrate; and

a pressure-sensitive adhesive disposed between the first substrate and the second substrate, wherein the pressure-sensitive adhesive comprises the adhesive composition of any one of claims 1-14.
BB. The adhesive assembly of embodiment AA, wherein each of the first substrate and the second substrate comprises a rigid surface, a tape backing, a film, a sheet, or a release liner.
CC. The adhesive assembly of embodiment BB, wherein the first substrate comprises a polymeric film selected from a fluorothermoplastic film, a polyester film, a polyamide film, a poly(meth)acrylate film, a polyolefin film, or a polycarbonate film.
DD. The adhesive assembly of embodiment CC, wherein the second substrate comprises a rigid substrate selected from glass, ceramic, porcelain, polymer, metal, or wood.
EE. The adhesive assembly of embodiment DD, wherein the second substrate comprises a window, a vehicle windshield, or an electronic display device.
FF. The adhesive assembly of embodiment EE, wherein the second substrate comprises an electronic display device selected from a television, a computer monitor, a cellular phone display, a laptop computer display, a notebook computer display, or a tablet computer display, and further wherein the pressure-sensitive adhesive is optically clear and stretch releasable.

Various aspects and advantages of illustrative embodiments of the disclosure have been summarized. The above Summary is not intended to describe each illustrated embodiment or every implementation of the present certain illustrative embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a side view of a silicone-based adhesive composition according to the present disclosure, attached to two substrates.

In the drawings, like reference numerals indicate like elements. While the above-identified drawings, which may not be drawn to scale, sets forth various embodiments of the present disclosure, other embodiments are also contemplated, as noted in the Detailed Description. In all cases, this disclosure describes the presently disclosed disclosure by way of representation of illustrative embodiments and not by express limitations. It should be understood that numerous other modifications and embodiments can be devised by those skilled in the art, which fall within the scope and spirit of this disclosure.

### DETAILED DESCRIPTION

For each of the following defined terms in the Glossary, these definitions shall be applied for the entire application, unless a different definition is provided in the claims or elsewhere in the specification.

### Glossary

It should understood that as used herein:

The term “film” refers to a thin sheet or strip of flexible material;

The term “adhesive” as used herein refers to polymeric compositions useful to adhere together two adherends. An example of an adhesive is a pressure sensitive adhesive. Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “copolymer” means a polymer formed from at least two chemically distinct monomer units, and includes random, block and star (e.g. dendritic) copolymers.

The term “silicone polyurea block copolymer” refers to a block copolymer containing at least two silicone segments connected to one or more non-silicone segments through urea linkages.

The term “urea-based” as used herein refers to macromolecules that are segmented copolymers which contain at least one urea linkage.

The term “amide-based” as used herein refers to macromolecules that are segmented copolymers which contain at least one amide linkage.

The term “urethane-based” as used herein refers to macromolecules that are segmented copolymers which contain at least one urethane linkage.

The term “silicone-based” as used herein refers to macromolecules (e.g., (co)polymers) that contain silicone units.

The terms silicone or siloxane are used interchangeably and refer to units with a siloxane (—Si(R¹)₂O—) repeating units where R¹ is defined below. In many embodiments, R¹ is an alkyl.

The term “polyisocyanate” refers to a compound having more than one isocyanate group. As used herein, the term “polyamine” refers to a compound having more than one amino group.

The term “organic polyamine” refers to a polyamine that does not include a silicone group.

The term “alkenyl” refers to a monovalent group that is a radical of an alkene, which is a hydrocarbon with at least one carbon-carbon double bond. The alkenyl can be linear, branched, cyclic, or combinations thereof and typically contains 2 to 20 carbon atoms. In some embodiments, the alkenyl contains 2 to 18, 2 to 12, 2 to 10, 4 to 10, 4 to 8, 2 to 8, 2 to 6, or 2 to 4 carbon atoms. Exemplary alkenyl groups include ethenyl, n-propenyl, and n-butenyl.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “halo” refers to fluoro, chloro, bromo, or iodo.

The term “haloalkyl” refers to an alkyl having at least one hydrogen atom replaced with a halo. Some haloalkyl groups are fluoroalkyl groups, chloroalkyl groups, and bromoalkyl groups. The term “perfluoroalkyl” refers to an alkyl group in which all hydrogen atoms are replaced by fluorine atoms.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “heteroalkylene” refers to a divalent group that includes at least two alkylene groups connected by a thio, oxy, or —NR— where R is alkyl. The heteroalkylene can be linear, branched, cyclic, substituted with alkyl groups, or combinations thereof. Some heteroalkylenes are poloxyyalkylenes where the heteroatom is oxygen such as for example, —CH₂CH₂(OCH₂CH₂)ₙOCH₂CH₂—.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “heteroarylene” refers to a divalent group that is carbocyclic and aromatic and contains heteroatoms such as sulfur, oxygen, nitrogen or halogens such as fluorine, chlorine, bromine or iodine.

The term “aralkylene” refers to a divalent group of formula —R^{a}—Ar^{a}— where R^{a} is an alkylene and Ar^{a} is an arylene (i.e., an alkylene is bonded to an arylene).

The term “alkoxy” refers to a monovalent group of formula —OR where R is an alkyl group.

The term “optically clear” refers to a material such as a film or adhesive layer that has a luminous transmission of at least 90 percent and a haze no greater than 5 percent in the 400 to 700 nanometer wavelength range for a sample having a thickness of approximately 25 micrometers (0.001 inch). An optically clear material often has a luminous transmission of at least about 90 percent and a haze of less than about 2 percent in the 400 to 700 nm wavelength range. Both the luminous transmission and the haze can be determined using, for example, the method of ASTM-D 1003-95.

The term “extensible” refers to materials that are capable of being stretched without breaking or snapping under stretch releasing conditions.

The term “stretch releasing” refers to a property of an extensible adhesive, tape, or film. Stretch releasing adhesives, tapes, and films form an adhesive bond to at least one substrate and then release from the substrate or substrates upon stretching. Typically, the stretch releasing adhesives, tapes or films may be cleanly removable from the substrate or substrates with little or no visible residue remaining on the substrate and no visible damage to the substrate.

The term “cleanly releases” means releases without leaving residue visible to an unaided human when observed under a 60 watt tungsten lamp at a distance of 10 cm;

The term “optical element” refers to an article that has an optical effect or optical application. The optical elements can be used, for example, in electronic displays, projection applications, photonics applications, and graphics applications.

The term “optically coupled” means that the any air gap between the first substrate and the second substrate has been eliminated. An air gap can lead to mismatching of refractive indexes. The optical coupling of the substrates often leads to enhanced brightness and enhanced contrast.

The terms “about” or “approximately” with reference to a numerical value or a shape means+/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

The term “adjoining” with reference to a particular layer means joined with or attached to another layer, in a position wherein the two layers are either next to (i.e., adjacent to) and directly contacting each other, or contiguous with each other but not in direct contact (i.e., there are one or more additional layers intervening between the layers).

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture.

By using the term “overcoated” to describe the position of a layer with respect to a substrate or other element of an article of the present disclosure, we refer to the layer as being atop the substrate or other element, but not necessarily contiguous to either the substrate or the other element.

By using the term “separated by” to describe the position of a layer with respect to other layers, we refer to the layer as being positioned between two other layers but not necessarily contiguous to or adjacent to either layer.

As used in this specification including the appended claims, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification including the appended claims, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the specification can be varied depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Illustrative embodiments of the present disclosure may take on various modifications and alterations without departing from the spirit and scope of the disclosure. Accordingly, it is to be understood that the embodiments of the present disclosure are not to be limited to the following described illustrative embodiments, but are to be controlled by the limitations set forth in the claims and any equivalents thereof.

Pressure-sensitive adhesive compositions are often left in place on a release liner until the adhesive layer is converted, packaged, or shipped to ultimate users, and in many instances the release liner is left in place until the adhesive is adhered to another substrate. As a result, a pressure-sensitive adhesive coated release liner potentially may experience a variety of environmental conditions including changes in temperature and humidity. The release liner should nevertheless remain functional and provide release of the adhesive to the end-use substrate over extended periods of time.

For end-use articles that include silicone-based pressure-sensitive adhesive compositions adhered to an end-use substrate, an undesirable degree of adhesion build often occurs before the end of the useful life of the end-use article or substrate, thereby effectively decreasing the useful life of the article, or preventing easy removal of the adhesive from the end-use substrate without leaving behind adhesive residues on a surface of the end-use substrate. This can be particularly problematic for adhesive film articles; e.g., hard-coated protection films, anti-reflective films, privacy films, tactile films, and the like; when adhered to glass-like end-use substrates such as windows or displays for electronic devices, e.g., televisions, computer monitors, cellular phones, laptop computers, notebook computers, computer tablets, and the like.

Unfortunately, the strength of the adhesive bond formed between a silicone-based pressure-sensitive adhesive composition and a release liner or an end-use substrate tends to increase over time and upon exposure to elevated temperatures. This phenomenon is referred to as “adhesion build.” If the strength of the bond between the adhesive composition and the release liner or end-use substrate is too great, the adhesive composition and the release liner or end-use substrate cannot be separated from each other or can be separated only with difficulty, rendering the adhesive unsuitable for its intended purpose or frustrating the user.

A number of attempts have been made to decrease the degree of adhesion build between an adhesive and a release liner or end-use substrate. One useful method involves altering the surface chemistry of the liner by coating the liner with a surface chemistry modifier. Fluorosilicones are a common class of surface chemistry modifiers that have been coated on liners to improve their release properties. Although some of these methods have reduced the adhesion level, adhesion build continues to occur and the rate of adhesion build remains undesirable.

It would be desirable to achieve a silicone-based pressure-sensitive adhesive article that includes a silicone-based pressure-sensitive adhesive composition in contact with a release liner and that can be stored for an extended period of time, and which exhibit a sufficiently low adhesion build such that the adhesive composition releases cleanly and relatively easily from the release liner and the end-use substrate. It also would be desirable to achieve a stretch releasing pressure-sensitive adhesive article that can be stored for an extended period of time and exhibit a sufficiently low adhesion build to the release liner and the end-use substrate such that the adhesive composition releases cleanly and relatively easily from the release liner and the end-use substrate, even after aging at elevated temperatures for months or years.

For some end-use applications, e.g., the application of hard-coated protection films, anti-reflective films, privacy films, tactile films, and the like adhered to glass-like end-use substrates, it would also be desirable for the pressure-sensitive adhesive composition to be self-wetting to the end-use substrate. A self-wetting (also called auto-wetting) pressure-sensitive adhesive material is generally coated onto a first substrate, e.g., a film. The self-wetting pressure-sensitive adhesive layer in this construction may be protected before use, for example, with a release liner.

The end-user peels the release liner from the self-wetting pressure-sensitive adhesive layer and places the film adhesive-side down onto a glass-like end-use substrate, for example, a window or a display for an electronic device such as, for example, a television, computer monitor, cellular phone, laptop computer notebook computers, computer tablet, and the like. With little or no added pressure, the self-wetting adhesive layer on the film will spontaneously wet the surface of the end-use substrate and thereby form a continuous, substantially void-free layer on the substrate surface. Any air bubbles trapped between the film and the end-use substrate can be readily removed by pushing the bubbles out of the edges of the film.

Thus, in one aspect, the present disclosure describes an adhesive composition including an elastomeric silicone-based copolymer selected from the group consisting of urea-based silicone copolymers, oxamide-based silicone copolymers, amide-based silicone copolymers, urethane-based silicone copolymers, and mixtures thereof; and greater than 0% by weight and no more than 20% by weight of MQ resin. In certain presently preferred embodiments, the adhesive composition includes less than 10% by weight of MQ resin. The adhesive is typically optically clear and can be used to couple two substrates together.

In some illustrative embodiments, the adhesive composition is a pressure-sensitive adhesive. In certain illustrative embodiments, the pressure sensitive adhesive is optically clear. In further illustrative embodiments, the pressure sensitive adhesive is applied to at least one major surface of a substrate.

In some illustrative embodiments, the pressure sensitive adhesive film is extensible, stretch releasable, and preferably cleanly removable from a variety of substrates including, e.g., glass, ceramic, painted wallboard, finished (e.g., stained and varnished) wood and plastics. Plastic substrates include, for example, polyesters such as PET (polyethylene terephthalate), polyacrylates such as PMMA (poly methylmethacrylate), polycarbonates, and the like. The pressure sensitive adhesive film, after having been bonded to a substrate, is also capable of being removed from the substrate without damaging the substrate.

The silicone-based adhesive compositions comprise at least one silicone elastomeric copolymer and a low level of tackifying resins. Suitable silicone-based adhesive compositions include for example, urea-based silicone copolymers, oxamide-based silicone copolymers, amide-based silicone copolymers, urethane-based silicone copolymers, and mixtures thereof, and contain low levels (i.e., no more than 20% by weight, 15% by weight, 10% by weight, 7.5% by weight, 5% by weight, 2.5% by weight, or even less than 1% by weight) of tackifying resin, preferably MQ tackifying resin.

One example of a useful class of silicone elastomeric copolymers is urea-based silicone elastomeric copolymers such as silicone polyurea block copolymers. Silicone polyurea block copolymers include the reaction product of a polydiorganosiloxane diamine (also referred to as a silicone diamine), a diisocyanate, and optionally an organic polyamine. Suitable silicone polyurea block copolymers are represented by the repeating unit:

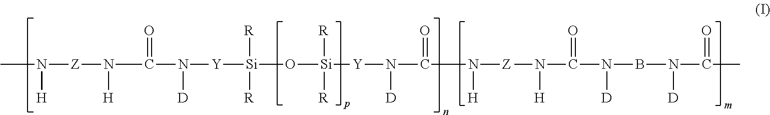

wherein

each R is a moiety that, independently, is an alkyl moiety, having about 1 to 12 carbon atoms, and may be substituted with, for example, trifluoroalkyl or vinyl groups, a vinyl radical or higher alkenyl radical represented by the formula R²(CH₂)ₐCH═CH₂ wherein R² is —(CH₂)_{b}— or —(CH₂)_{c}CH═CH— and a is 1,2 or 3; b is 0, 3 or 6; and c is 3, 4 or 5, a cycloalkyl moiety having from about 6 to 12 carbon atoms and may be substituted with alkyl, fluoroalkyl, and vinyl groups, or an aryl moiety having from about 6 to 20 carbon atoms and may be substituted with, for example, alkyl, cycloalkyl, fluoroalkyl and vinyl groups or R is a perfluoroalkyl group as described in U.S. Pat. No. 5,028,679, or a fluorine-containing group, as described in U.S. Pat. No. 5,236,997, or a perfluoroether-containing group, as described in U.S. Pat. Nos. 4,900,474 and 5,118,775; typically, at least 50% of the R moieties are methyl radicals with the balance being monovalent alkyl or substituted alkyl radicals having from 1 to 12 carbon atoms, alkenyl radicals, phenyl radicals, or substituted phenyl radicals;

each Z is a polyvalent radical that is an arylene radical or an aralkylene radical having from about 6 to 20 carbon atoms, an alkylene or cycloalkylene radical having from about 6 to 20 carbon atoms, in some embodiments Z is 2,6-tolylene, 4,4′-methylenediphenylene, 3,3′-dimethoxy-4,4′-biphenylene, tetramethyl-m-xylylene, 4,4′-methylenedicyclohexylene, 3,5,5-trimethyl-3-methylenecyclohexylcne, 1,6-hexamethylene, 1,4-cyclohexylene, 2,2,4-trimethylhexylene and mixtures thereof;

each Y is a polyvalent radical that independently is an alkylene radical of 1 to 10 carbon atoms, an aralkylene radical or an arylene radical having 6 to 20 carbon atoms;

each D is selected from the group consisting of hydrogen, an alkyl radical of 1 to 10 carbon atoms, phenyl, and a radical that completes a ring structure including B or Y to form a heterocycle;

where B is a polyvalent radical selected from the group consisting of alkylene, aralkylene, cycloalkylene, phenylene, heteroalkylene, including for example, polyethylene oxide, polypropylene oxide, polytetramethylene oxide, and copolymers and mixtures thereof;

m is a number that is 0 to about 1000;

n is a number that is at least 1; and

p is a number that is at least 10, in some embodiments 15 to about 2000, or even 30 to 1500.

Useful silicone polyurea block copolymers are disclosed in, e.g., U.S. Pat. Nos. 5,512,650, 5,214,119, 5,461,134, and 7,153,924 and PCT Publication Nos. WO 96/35458, WO 98/17726, WO 96/34028, WO 96/34030 and WO 97/40103.

Examples of useful silicone diamines used in the preparation of silicone polyurea block copolymers include polydiorganosiloxane diamines represented by formula II

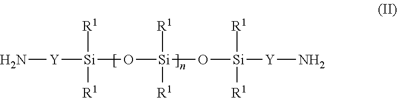

where each R¹ is independently an alkyl, haloalkyl, aralkyl, alkenyl, aryl, or aryl substituted with an alkyl, alkoxy, or halo, each Y is independently an alkylene, aralkylene, or a combination thereof, and n is an integer of 0 to 1500.

The polydiorganosiloxane diamine of Formula II can be prepared by any known method and can have any suitable molecular weight, such as an average molecular weight in the range of 700 to 150,000 g/mole. Suitable polydiorganosiloxane diamines and methods of making the polydiorganosiloxane diamines are described, for example, in U.S. Pat. Nos. 3,890,269, 4,661,577, 5,026,890, 5,276,122, 5,214,119, 5,461,134, 5,512,650, and 6,355,759. Some polydiorganosiloxane diamines are commercially available, for example, from Shin Etsu Silicones of America, Inc., Torrance, Calif. and from Gelest Inc., Morrisville, Pa.

A polydiorganosiloxane diamine having a molecular weight greater than 2,000 g/mole or greater than 5,000 g/mole can be prepared using the methods described in U.S. Pat. Nos. 5,214,119, 5,461,134, and 5,512,650. One of the described methods involves combining under reaction conditions and under an inert atmosphere (a) an amine functional end blocker of the following formula

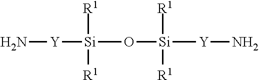

where Y and R¹ are the same as defined for Formula II; (b) sufficient cyclic siloxane to react with the amine functional end blocker to form a polydiorganosiloxane diamine having a molecular weight less than 2,000 g/mole; and (c) an anhydrous aminoalkyl silanolate catalyst of the following formula

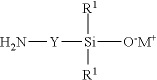

where Y and R¹ are the same as defined in Formula II and M⁺ is a sodium ion, potassium ion, cesium ion, rubidium ion, or tetramethylammonium ion. The reaction is continued until substantially all of the amine functional end blocker is consumed and then additional cyclic siloxane is added to increase the molecular weight. The additional cyclic siloxane is often added slowly (e.g., drop wise). The reaction temperature is often conducted in the range of 80° C. to 90° C. with a reaction time of 5 to 7 hours. The resulting polydiorganosiloxane diamine can be of high purity (e.g., less than 2 weight percent, less than 1.5 weight percent, less than 1 weight percent, less than 0.5 weight percent, less than 0.1 weight percent, less than 0.05 weight percent, or less than 0.01 weight percent silanol impurities). Altering the ratio of the amine functional end blocker to the cyclic siloxane can be used to vary the molecular weight of the resulting polydiorganosiloxane diamine of Formula II.

Another method of preparing the polydiorganosiloxane diamine of Formula II includes combining under reaction conditions and under an inert atmosphere (a) an amine functional end blocker of the following formula

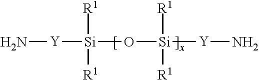

where R¹ and Y are the same as described for Formula I and where the subscript x is equal to an integer of 1 to 150; (b) sufficient cyclic siloxane to obtain a polydiorganosiloxane diamine having an average molecular weight greater than the average molecular weight of the amine functional end blocker; and (c) a catalyst selected from cesium hydroxide, cesium silanolate, rubidium silanolate, cesium polysiloxanolate, rubidium polysiloxanolate, and mixtures thereof. The reaction is continued until substantially all of the amine functional end blocker is consumed. This method is further described in U.S. Pat. No. 6,355,759. This procedure can be used to prepare any molecular weight of the polydiorganosiloxane diamine.

Yet another method of preparing the polydiorganosiloxane diamine of Formula II is described in U.S. Pat. No. 6,531,620. In this method, a cyclic silazane is reacted with a siloxane material having hydroxy end groups as shown in the following reaction.

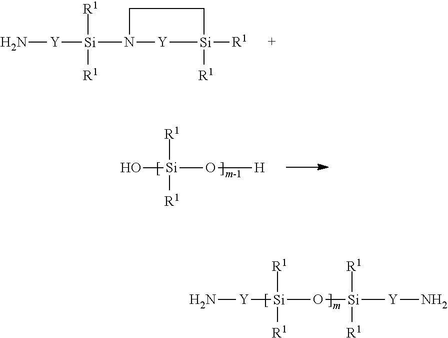

The groups R¹ and Y are same as described for Formula II. The subscript m is an integer greater than 1.

Examples of polydiorganosiloxane diamines include, but are not limited to, polydimethylsiloxane diamine, polydiphenylsiloxane diamine, polytrifluoropropylmethylsiloxane diamine, polyphenylmethylsiloxane diamine, polydiethylsiloxane diamine, polydivinylsiloxane diamine, polyvinylmethylsiloxane diamine, poly(5-hexenyl)methylsiloxane diamine, and mixtures thereof.

The polydiorganosiloxane diamine component provides a means of adjusting the modulus of the resultant silicone polyurea block copolymer. In general, high molecular weight polydiorganosiloxane diamines provide copolymers of lower modulus whereas low molecular polydiorganosiloxane polyamines provide copolymers of higher modulus.

Examples of useful polyamines include polyoxyalkylene diamines including, e.g., polyoxyalkylene diamines commercially available under the trade designation D-230, D-400, D-2000, D-4000, ED-2001 and EDR-148 from Hunstman Corporation (Houston, Tex.), polyoxyalkylene triamines including, e.g., polyoxyalkylene triamines commercially available under the trade designations T-403, T-3000 and T-5000 from Hunstman, and polyalkylenes including, e.g., ethylene diamine and polyalkylenes available under the trade designations DYTEK A and DYTEK EP from DuPont (Wilmington, Del.).

The optional polyamine provides a means of modifying the modulus of the copolymer. The concentration, type and molecular weight of the organic polyamine influence the modulus of the silicone polyurea block copolymer.

The silicone polyurea block copolymer may include polyamine in an amount of no greater than about 3 moles, in some embodiments from about 0.25 to about 2 moles. Typically the polyamine has a molecular weight of no greater than about 300 g/mole.

Any polyisocyanate including, e.g., diisocyanates and triisocyanates, capable of reacting with the above-described polyamines can be used in the preparation of the silicone polyurea block copolymer. Examples of suitable diisocyanates include aromatic diisocyanates, such as 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate), methylenediphenylene-4,4′-diisocyanate, polycarbodiimide-modified methylenediphenylene diisocyanate, (4,4′-diisocyanato-3,3′,5,5′-tetraethyl) diphenylmethane, 4,4-diisocyanato-3,3′-dimethoxybiphenyl (o-dianisidine diisocyanate), 5-chloro-2,4-toluene diisocyanate, and 1-chloromethyl-2,4-diisocyanato benzene, aromatic-aliphatic diisocyanates, such as m-xylylene diisocyanate and tetramethyl-m-xylylene diisocyanate, aliphatic diisocyanates such as 1,4-diisocyanatobutane, 1,6-diisocyanatohexane, 1,12-diisocyanatododecane and 2-methyl-1,5-diisocyanatopentane, and cycloaliphatic diisocyanates such as methylenedicyclohexylene-4,4′-diisocyanate, 3-isocyanatomethyl-3,5,5-trimethylcyclohexyl isocyanate (isophorone diisocyanate) and cyclohexylene-1,4-diisocyanate.

Any triisocyanate that can react with a polyamine, and in particular with the polydiorganosiloxane diamine is suitable. Examples of such triisocyanates include, e.g., polyfunctional isocyanates, such as those produced from biurets, isocyanurates, and adducts. Examples of commercially available polyisocyanates include portions of the series of polyisocyanates available under the trade designations DESMODUR and MONDUR from Bayer and PAPI from Dow Plastics.

The polyisocyanate is typically present in a stoichiometric amount based on the amount of polydiorganosiloxane diamine and optional polyamine.

Another useful class of silicone elastomeric copolymers are oxamide-based polymers such as polydiorganosiloxane polyoxamide block copolymers. Examples of polydiorganosiloxane polyoxamide block copolymers are presented, for example, in US Patent Publication No. 2007-0148475. The polydiorganosiloxane polyoxamide block copolymer contains at least two repeat units of Formula III.

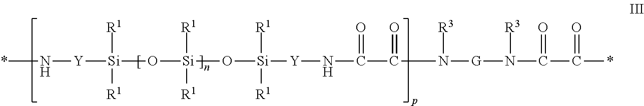

In this formula, each R¹ is independently an alkyl, haloalkyl, aralkyl, alkenyl, aryl, or aryl substituted with an alkyl, alkoxy, or halo, wherein at least 50 percent of the R¹ groups are methyl. Each Y is independently an alkylene, aralkylene, or a combination thereof. Subscript n is independently an integer of 40 to 1500 and the subscript p is an integer of 1 to 10. Group G is a divalent group that is the residue unit that is equal to a diamine of formula R³HN-G-NHR³ minus the two —NHR³ groups. Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine or the like). Each asterisk (*) indicates a site of attachment of the repeat unit to another group in the copolymer such as, for example, another repeat unit of Formula III.

Suitable alkyl groups for R¹ in Formula III typically have 1 to 10, 1 to 6, or 1 to 4 carbon atoms. Exemplary alkyl groups include, but are not limited to, methyl, ethyl, isopropyl, n-propyl, n-butyl, and iso-butyl. Suitable haloalkyl groups for R¹ often have only a portion of the hydrogen atoms of the corresponding alkyl group replaced with a halogen. Exemplary haloalkyl groups include chloroalkyl and fluoroalkyl groups with 1 to 3 halo atoms and 3 to 10 carbon atoms. Suitable alkenyl groups for R¹ often have 2 to 10 carbon atoms. Exemplary alkenyl groups often have 2 to 8, 2 to 6, or 2 to 4 carbon atoms such as ethenyl, n-propenyl, and n-butenyl. Suitable aryl groups for R¹ often have 6 to 12 carbon atoms. Phenyl is an exemplary aryl group. The aryl group can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). Suitable aralkyl groups for R¹ usually have an alkylene group having 1 to 10 carbon atoms and an aryl group having 6 to 12 carbon atoms. In some exemplary aralkyl groups, the aryl group is phenyl and the alkylene group has 1 to 10 carbon atoms, 1 to 6 carbon atoms, or 1 to 4 carbon atoms (i.e., the structure of the aralkyl is alkylene-phenyl where an alkylene is bonded to a phenyl group).

At least 50 percent of the R¹ groups are methyl. For example, at least 60 percent, at least 70 percent, at least 80 percent, at least 90 percent, at least 95 percent, at least 98 percent, or at least 99 percent of the R¹ groups can be methyl. The remaining R¹ groups can be selected from an alkyl having at least two carbon atoms, haloalkyl, aralkyl, alkenyl, aryl, or aryl substituted with an alkyl, alkoxy, or halo.

Each Y in Formula III is independently an alkylene, aralkylene, or a combination thereof. Suitable alkylene groups typically have up to 10 carbon atoms, up to 8 carbon atoms, up to 6 carbon atoms, or up to 4 carbon atoms. Exemplary alkylene groups include methylene, ethylene, propylene, butylene, and the like. Suitable aralkylene groups usually have an arylene group having 6 to 12 carbon atoms bonded to an alkylene group having 1 to 10 carbon atoms. In some exemplary aralkylene groups, the arylene portion is phenylene. That is, the divalent aralkylene group is phenylene-alkylene where the phenylene is bonded to an alkylene having 1 to 10, 1 to 8, 1 to 6, or 1 to 4 carbon atoms. As used herein with reference to group Y, “a combination thereof” refers to a combination of two or more groups selected from an alkylene and aralkylene group. A combination can be, for example, a single aralkylene bonded to a single alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

Each subscript n in Formula III is independently an integer of 40 to 1500. For example, subscript n can be an integer up to 1000, up to 500, up to 400, up to 300, up to 200, up to 100, up to 80, or up to 60. The value of n is often at least 40, at least 45, at least 50, or at least 55. For example, subscript n can be in the range of 40 to 1000, 40 to 500, 50 to 500, 50 to 400, 50 to 300, 50 to 200, 50 to100, 50 to 80, or 50 to 60.

The subscript p is an integer of 1 to 10. For example, the value of p is often an integer up to 9, up to 8, up to 7, up to 6, up to 5, up to 4, up to 3, or up to 2. The value of p can be in the range of 1 to 8, 1 to 6, or 1 to 4.

Group G in Formula III is a residual unit that is equal to a diamine compound of formula R³HN-G-NHR³ minus the two amino groups (i.e., —NHR³ groups). Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine). The diamine can have primary or secondary amino groups. In most embodiments, R³ is hydrogen or an alkyl. In many embodiments, both of the amino groups of the diamine are primary amino groups (i.e., both R³ groups are hydrogen) and the diamine is of formula H₂N-G-NH₂.

In some embodiments, G is an alkylene, heteroalkylene, polydiorganosiloxane, arylene, aralkylene, or a combination thereof. Suitable alkylenes often have 2 to 10, 2 to 6, or 2 to 4 carbon atoms. Exemplary alkylene groups include ethylene, propylene, butylene, and the like. Suitable heteroalkylenes are often polyoxyalkylenes such as polyoxyethylene having at least 2 ethylene units, polyoxypropylene having at least 2 propylene units, or copolymers thereof. Suitable polydiorganosiloxanes include the polydiorganosiloxane diamines of Formula II, which are described above, minus the two amino groups. Exemplary polydiorganosiloxanes include, but are not limited to, polydimethylsiloxanes with alkylene Y groups. Suitable aralkylene groups usually contain an arylene group having 6 to 12 carbon atoms bonded to an alkylene group having 1 to 10 carbon atoms. Some exemplary aralkylene groups are phenylene-alkylene where the phenylene is bonded to an alkylene having 1 to 10 carbon atoms, 1 to 8 carbon atoms, 1 to 6 carbon atoms, or 1 to 4 carbon atoms. As used herein with reference to group G, “a combination thereof” refers to a combination of two or more groups selected from an alkylene, heteroalkylene, polydiorganosiloxane, arylene, and aralkylene. A combination can be, for example, an aralkylene bonded to an alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

The polydiorganosiloxane polyoxamide tends to be free of groups having a formula —R^{a}—(CO)—NH— where R^{a} is an alkylene. All of the carbonylamino groups along the backbone of the copolymeric material are part of an oxalylamino group (i.e., the —(CO)—(CO)—NH— group). That is, any carbonyl group along the backbone of the copolymeric material is bonded to another carbonyl group and is part of an oxalyl group. More specifically, the polydiorganosiloxane polyoxamide has a plurality of aminoxalylamino groups.

The polydiorganosiloxane polyoxamide is a linear, block copolymer and is an elastomeric material. Unlike many of the known polydiorganosiloxane polyamides that are generally formulated as brittle solids or hard plastics, the polydiorganosiloxane polyoxamides can be formulated to include greater than 50 weight percent polydiorganosiloxane segments based on the weight of the copolymer. The weight percent of the diorganosiloxane in the polydiorganosiloxane polyoxamides can be increased by using higher molecular weight polydiorganosiloxanes segments to provide greater than 60 weight percent, greater than 70 weight percent, greater than 80 weight percent, greater than 90 weight percent, greater than 95 weight percent, or greater than 98 weight percent of the polydiorganosiloxane segments in the polydiorganosiloxane polyoxamides. Higher amounts of the polydiorganosiloxane can be used to prepare elastomeric materials with lower modulus while maintaining reasonable strength.

Some of the polydiorganosiloxane polyoxamides can be heated to a temperature up to 200° C., up to 225° C., up to 250° C., up to 275° C., or up to 300° C. without noticeable degradation of the material. For example, when heated in a thermogravimetric analyzer in the presence of air, the copolymers often have less than a 10 percent weight loss when scanned at a rate 50° C. per minute in the range of 20° C. to about 350° C. Additionally, the copolymers can often be heated at a temperature such as 250° C. for 1 hour in air without apparent degradation as determined by no detectable loss of mechanical strength upon cooling.

The polydiorganosiloxane polyoxamide copolymers have many of the desirable features of polysiloxanes such as low glass transition temperatures, thermal and oxidative stability, resistance to ultraviolet radiation, low surface energy and hydrophobicity, and high permeability to many gases. Additionally, the copolymers exhibit good to excellent mechanical strength.

Another useful class of silicone elastomeric copolymers is amide-based silicone elastomeric copolymers. Such polymers are similar to the urea-based polymers, containing amide linkages (—N(D)-C(O)—) instead of urea linkages (—N(D)-C(O)—N(D)-), where C(O) represents a carbonyl group and D is a hydrogen or alkyl group. Such polymers may be prepared in a variety of different ways. Starting from the polydiorganosiloxane diamine described above in Formula II, the amide-based polymer can be prepared by reaction with a poly-carboxylic acid or a poly-carboxylic acid derivative such as, for example di-esters. In some embodiments, an amide-based silicone elastomer is prepared by the reaction of a polydiorganosiloxane diamine and di-methyl salicylate of adipic acid.

An alternative reaction pathway to amide-based silicone elastomers utilizes a silicone di-carboxylic acid derivative such as a carboxylic acid ester. Silicone carboxylic acid esters can be prepared through the hydrosilation reaction of a silicone hydride (i.e. a silicone terminated with a silicon-hydride (Si—H) bonds) and an ethylenically unsaturated ester. For example a silicone di-hydride can be reacted with an ethylenically unsaturated ester such as, for example, CH₂═CH—(CH₂)ₙ—C(O)—OR, where C(O) represents a carbonyl group and n is an integer up to 15, and R is an alkyl, aryl or substituted aryl group, to yield a silicone chain capped with —Si—(CH₂)ₙ₋₂—C(O)—OR. The —C(O)—OR group is a carboxylic acid derivative which can be reacted with a silicone diamine, a polyamine or a combination thereof. Suitable silicone diamines and polyamines have been discussed above and include aliphatic, aromatic or oligomeric diamines (such as ethylene diamine, phenylene diamine, xylylene diamine, polyoxalkylene diamines, etc).

Another useful class of silicone elastomeric copolymers is urethane-based silicone elastomeric copolymers such as silicone polyurea-urethane block copolymers. Silicone polyurea-urethane block copolymers include the reaction product of a polydiorganosiloxane diamine (also referred to as silicone diamine), a diisocyanate, and an organic polyol. Such materials are structurally very similar to the structure of Formula I except that the —N(D)-B—N(D)- links are replaced by —O—B—O— links. Examples are such polymers are presented, for example, in U.S. Pat. No. 5,214,119.

These urethane-based silicone elastomeric copolymers are prepared in the same fashion as the urea-based silicone elastomeric copolymers except that an organic polyol is substituted for an organic polyamine. Typically, since the reaction between a alcohol group and an isocyanate group is slower than the reaction between a amine group and an isocyanate group, a catalyst such as a tin catalyst commonly used in polyurethane chemistry, is used.

The silicone elastomeric copolymers can be prepared by solvent-based processes, solventless processes or a combination thereof. Useful solvent-based processes are described in, e.g., Tyagi et al., “Segmented Organosiloxane Copolymers: 2. Thermal and Mechanical Properties of Siloxane-Urea Copolymers,” Polymer, vol. 25, December, 1984, and U.S. Pat. No. 5,214,119. Useful methods of manufacturing silicone elastomeric copolymers are also described in, e.g., U.S. Pat. Nos. 5,512,650, 5,214,119, and 5,461,134, US Patent Publication No. 2007-0148475, and PCT Publication Nos. WO 96/35458, WO 98/17726, WO 96/34028, and WO 97/40103.

Useful silicone-based pressure sensitive adhesive compositions typically include an MQ tackifying resin and a silicone elastomeric copolymer. The MQ tackifying resin and the silicone elastomeric copolymer generally are present in the form of a blend of MQ tackifying resin and silicone elastomeric copolymer. Typically the silicone elastomeric copolymer is present in the silicone-based pressure sensitive adhesive composition in an amount of from about 80% by weight to about 99% by weight, 85% by weight to 98% by weight, 88% by weight to 95% by weight, or even 89% by weight to 90% by weight.

The MQ tackifying resin is typically present in the silicone-based pressure sensitive adhesive composition in an amount of greater than 0% and no more than 20% by weight, from about 0.5% by weight to about 15% by weight, from about 1.0% by weight to less than 10% by weight, or from about 2.5% by weight to about 7.5% by weight, or even about 4.0% by weight to about 5.0% by weight.

Useful MQ tackifying resins include, e.g., MQ silicone resins, MQD silicone resins, and MQT silicone resins, which also may be referred to as copolymeric silicone resins and which typically have a number average molecular weight of about 100 to about 50,000, or about 500 to about 20,000 and generally have methyl substituents. The MQ silicone resins include both non-functional and functional resins, the functional resins having one or more functionalities including, for example, silicon-bonded hydrogen, silicon-bonded alkenyl, and silanol.

MQ silicone resins are copolymeric silicone resins having R′₃SiO_{1/2} units (M units) and SiO_{4/2} units (Q units). Such resins are described in, for example, Encyclopedia of Polymer Science and Engineering, vol. 15, John Wiley & Sons, New York, (1989), pp. 265 to 270, and U.S. Pat. Nos. 2,676,182; 3,627,851; 3,772,247; and 5,248,739. MQ silicone resins having functional groups are described in U.S. Pat. No. 4,774,310, which describes silyl hydride groups, U.S. Pat. No. 5,262,558, which describes vinyl and trifluoropropyl groups, and U.S. Pat. No. 4,707,531, which describes silyl hydride and vinyl groups. The above-described resins are generally prepared in solvent. Dried or solventless MQ silicone resins are prepared as described in U.S. Pat. Nos. 5,319,040; 5,302,685; and 4,935,484.

MQD silicone resins are terpolymers having R′₃ SiO_{1/2} units (M units), SiO_{4/2} units (Q units), and R′₂SiO_{2/2} units (D units) as described, e.g., in U.S. Pat. No. 5,110,890 and Japanese Kokai HEI 2-36234.

MQT silicone resins are terpolymers having R₃SiO_{1/2} units (M units), SiO_{4/2} units (Q units), and RSiO_{3/2} units (T units) (MQT resins).

Commercially available MQ resins include SR-545 MQ resin in toluene available from General Electric Co., Silicone Resins Division (Waterford, N.Y.), MQOH resins which are MQ silicone resins in toluene available from PCR, Inc. (Gainesville, Fla.). Such resins are generally supplied in organic solvent. These organic solutions of MQ silicone resin may be used as is or may be dried by any number of techniques known in the art including, e.g., spray drying, oven drying, and steam separation, to provide a MQ silicone resin at 100 percent non-volatile content. The MQ silicone resin can also include blends of two or more silicone resins.

Just as the silicone elastomeric copolymers may be made from a variety of processes, the silicone-based pressure sensitive adhesive compositions may also be prepared by a variety of processes. The compositions may be prepared in a solvent-based process, a solventless process or a combination thereof.

In solvent-based processes, the MQ silicone resin, if used, can be introduced before, during or after the reactants used to form the polymer, such as polyamines and polyisocyanates, have been introduced into the reaction mixture. The reaction may be carried out in a solvent or a mixture of solvents. The solvents are preferably nonreactive with the reactants. The starting materials and final products preferably remain completely miscible in the solvents during and after the completion of the polymerization. These reactions can be conducted at room temperature or up to the boiling point of the reaction solvent. The reaction is generally carried out at ambient temperature up to 50° C. Additionally, the elastomeric polymer may be prepared in a solvent mixture with the MQ resin added later, after the polymer has been formed.

In substantially solventless processes, the reactants used to form the polymer and the MQ silicone resin, if used, are mixed in a reactor and the reactants are allowed to react to form the silicone elastomeric copolymer, and thus form the pressure sensitive adhesive composition. Additionally, the silicone elastomeric copolymer can be made in a solventless process, in for example a mixer or extruder, and either be isolated or simply transferred to an extruder and mixed with MQ silicone resin.

One useful method that includes a combination of a solvent-based process and a solventless process includes preparing the silicone elastomeric copolymer using a solventless process and then mixing the silicone elastomeric copolymer with the MQ resin solution in a solvent.

In another aspect, the present disclosure describes optically clear, stretch releasable adhesive tapes or films, articles that contain the adhesive tapes or films, and uses of the adhesive tapes or films. The optically clear stretch releasing pressure sensitive adhesive may be in the form a film. Such a film may be free standing or may be disposed on a substrate. The substrate may be a release liner, a rigid surface, a tape backing, a film, or a sheet. The stretch releasing pressure sensitive adhesive film can be prepared using a variety of common methods for preparing pressure sensitive adhesive films. For example, the pressure sensitive adhesive composition can be coated onto a release liner, coated directly onto a substrate or a backing, or formed as a separate layer (e.g., coated onto a release liner) and then laminated to a substrate. In some embodiments the pressure sensitive adhesive film is a transfer tape, i.e. it is disposed between two release liners.

In some embodiments it may be desirable to impart a microstructured surface to one or both major surfaces of the adhesive. It may be desirable to have a microstructured surface on at least one surface of the adhesive to aid air egress during lamination. If it is desired to have a microstructured surface on one or both surfaces of the adhesive film, the adhesive coating or film may be placed on a tool or a liner containing microstructuring. The liner or tool can then be removed to expose an adhesive film having a microstructured surface. Generally with optical applications it is desirable that the microstructure disappear over time to prevent interference with optical properties.

In some embodiments the pressure sensitive adhesive film comprises a single layer. In other embodiments the pressure sensitive adhesive film comprises multiple layers, i.e. additional layers are present in addition to the pressure sensitive adhesive. Where multiple layers are present, the additional layers may be films, foams, or additional elastomers or pressure sensitive adhesives as long as the additional layers are optically clear and extensible and do inhibit the function of the optically clear stretch releasing pressure sensitive adhesive.

In some embodiments the stretch releasing pressure sensitive adhesive film can be in the form of a tape disposed on a backing. The backing can include single layer and multi-layer constructions. Useful backings include, e.g., a polymeric foam layer, a polymeric film layer, and combinations thereof, provided such backings have the proper optical and extensibility properties.

Potentially useful polymeric backing materials are disclosed in U.S. Pat. No. 5,516,581 and PCT Publication No. WO 95/06691.

Representative examples of potentially useful polymeric backing materials for polymeric foam layers or solid polymeric film layers include polyolefins, e.g., polyethylene, including high density polyethylene, low density polyethylene, linear low density polyethylene, and linear ultra low density polyethylene, polypropylene and polybutylenes; vinyl copolymers, e.g., polyvinyl chlorides, both plasticized and unplasticized, and polyvinyl acetates; olefin copolymers, e.g., ethylene/methacrylate copolymers, ethylene/vinylacetate copolymers, acrylonitrile-butadiene-styrene copolymers, and ethylene/propylene copolymers; acrylic polymers and copolymer; and combinations thereof. Mixtures or blends of any plastic or plastic and elastomer materials, such as polypropylene/polyethylene, polyurethane/polyolefin, polyurethane/polycarbonate, and polyurethane/polyester, can also be used.

Polymeric foams can be selected to optimize tape properties such as conformability and resiliency, which are useful when the tape is to be adhered to surfaces having surface irregularities, e.g., painted wallboard. Conformable and resilient polymeric foams are well suited for applications in which the adhesive tape is to be adhered to surfaces having surface irregularities. Such is the case with a typical wall surface. Polymeric foam layers for use in the backing generally will have a density of about 2 to about 30 pounds per cubic foot (about 32 to about 481 kg/m³), particularly in tape constructions where the foam is to be stretched to effect debonding.

Where only one polymeric film or foam layer of a multi-layer backing is intended to be stretched to effect debonding, that layer should exhibit sufficient physical properties and be of a sufficient thickness to achieve that objective.

Polymeric films may be used to increase load bearing strength and rupture strength of the tape. Films are particularly well suited to applications involving adhering smooth surfaces together. A polymeric film layer typically has a thickness of about 10 micrometers (0.4 mil) to about 254 micrometers (10 mils).

The backing can include an elastomeric material. Suitable elastomeric backing materials include, e.g., styrene-butadiene copolymer, polychloroprene (i.e., neoprene), nitrile rubber, butyl rubber, polysufide rubber, cis-1,4-polyisoprene, ethylene-propylene terpolymers (e.g., EPDM rubber), silicone rubber, silicone elastomers such as silicone polyurea block copolymers, polyurethane rubber, polyisobutylene, natural rubber, acrylate rubber, thermoplastic rubbers, e.g., styrene-butadiene block copolymers and styrene-isoprene-styrene block copolymers, and thermoplastic polyolefin rubber materials.

The adhesive tapes or films can be used to couple two substrates together. In certain such embodiments, the adhesive tapes or films can be used to optically couple the two substrates together. In many such applications, the second substrate can be viewed by looking through both the first substrate and the optically clear, stretch releasable adhesive tape or film. Because of the potential difficulties of retaining optical clarity and extensibility in a multilayer construction, in many embodiments the pressure sensitive adhesive film is often a single layer construction.

The adhesive tape may, in some illustrative embodiments, be stretch releasable (stretch releasing). In the event that the coupling of the two substrates is defective, the adhesive tape can, in certain illustrative embodiments, be removed easily and the two substrates can be easily separated. The two substrates can be separated without damaging either substrate. Consequently, after separation, the substrates can be used again. This is particularly advantageous when at least one of the substrates is expensive, fragile, or difficult to manufacture.

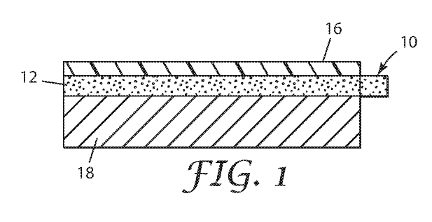

The optically clear, stretch releasing pressure sensitive adhesive film optionally includes a tacky tab, as illustrated in FIG. 1. In FIGS. 1, 16 and 18 are substrates and 12 is the optically clear and stretch releasing pressure sensitive adhesive film. The optically clear stretch releasing pressure sensitive adhesive film may optionally include a tacky tab, as illustrated in the FIG. 1. The tacky tab is represented by 10. The tacky tab, 10, can be grasped and pulled by a user to stretch the tape during the removal process, so as to remove the tape from the object or substrate to which it has been affixed. The tacky tab is an extension of the optically clear stretch releasing pressure sensitive adhesive. Because in many optical uses it is desirable to keep the size of the tab to a minimum, the tacky nature of the tab aids the grasping of the tab by the user.

While FIG. 1 shows one illustrative construction suitable for a user to stretch release the pressure sensitive adhesive, other constructions are possible. In particular it may be desirable for one of the substrates, either rigid or non-rigid, to have a segment which overlaps with the tacky tab. This overlap segment may serve to hide the tacky tab during the working life of the pressure sensitive adhesive but is not permanently adhered to it. Typically, the overlap is either removable or positioned in such a way as to not interfere with the user's grasp of the tacky tab. Examples of removable overlaps include tear away strips, break away segments of rigid substrates and the like.

In some applications it may be desirable to use a collection tool, such as a winding tool, to aid the stretch removal of the pressure sensitive adhesive film. Such a tool can aid in the collection of the pressure sensitive adhesive film as it is removed. An example of such a tool is a winding tool, that may be as simple as a piece of plastic, wood, metal, cardboard, and the like, to which the tacky tab is attached to permit winding of the pressure sensitive adhesive film as it is stretch removed, or it may be a more complex instrument. Collection of the pressure sensitive adhesive film with a collection tool may be more desirable than continuous linear stretching of the pressure sensitive adhesive film in instances where space is limited, such as, for example, in a factory assembly line.

In yet another aspect, the disclosure describes an adhesive assembly including a first substrate, a second substrate, and a pressure-sensitive adhesive disposed between the first substrate and the second substrate, wherein the pressure-sensitive adhesive includes any of the foregoing pressure-sensitive adhesive compositions.

In certain illustrative embodiments, the first substrate and the second substrate are a rigid surface, a tape backing, a film, a sheet, or a release liner. In some such embodiments, the first substrate is a polymeric film selected from a fluorothermoplastic film, a polyester film, a polyamide film, a poly(meth)acrylate film, a polyolefin film, or a polycarbonate film. In other illustrative embodiments, the second substrate is a rigid substrate selected from glass, ceramic, porcelain, polymer, metal, or wood. In additional illustrative embodiments, the second substrate is a window, a vehicle windshield, or an electronic display device. In certain such embodiments, the second substrate comprises an electronic display device selected from a television, a computer monitor, a cellular phone display, a laptop computer display, a notebook computer display, or a tablet computer display, and further wherein the pressure-sensitive adhesive is optically clear and stretch releasable.

The stretch releasing pressure sensitive adhesive film may be used to make various adhesive articles or adhesive assemblies. Such articles include optical articles which may include an optical film, a substrate or both. Optical articles may be used in wide array of optical applications including information displays, window coverings, graphic articles, handheld electronic devices, projection systems, protective films, touch sensors and the like. Examples of information display devices include devices with a wide range of display area configurations including liquid crystal displays, plasma displays, front and rear projection displays, cathode ray tubes and signage. Such display area configurations can be employed in a variety of portable and non-portable information display devices including personal digital assistants, cell phones, touch-sensitive screens, wrist watches, car navigation systems, global positioning systems, depth finders, calculators, electronic books, CD or DVD players, projection television screens, computer monitors, notebook computer displays, instrument gauges, instrument panel covers, signage such as graphic displays (including indoor and outdoor graphics, bumper stickers, etc) reflective sheeting and the like.

In some illustrative embodiments, adhesive assemblies are provided that include two rigid substrates and a pressure sensitive adhesive film between the two rigid substrates. As used herein, the term “rigid substrate” refers to substrates that are rigid or substantially rigid. For example, rigid substrates include glass sheets, rigid polymeric sheets and display surfaces. Examples of applications where lamination of one rigid substrate to another rigid substrate include, for example, CRT (cathode ray tube) and LCD (liquid crystal display) display screens protected by a rigid sheet such as antireflection (AR) or protective cover glass.

Examples of suitable devices that may utilize such laminations include such devices as portable and non-portable information display devices including personal digital assistants, cell phones, touch-sensitive screens, wrist watches, car navigation systems, global positioning systems, projection television screens, computer monitors, notebook computer displays, and the like. It has been observed that bonding of the rigid cover to the display screen, and thus eliminating any air gap between them, provides improvement in the quality of the displayed image.

Stretch releasing optically clear pressure sensitive adhesives are particularly useful in such systems, because, if defects are detected during fabrication of the devices containing them, the rigid cover can be removed by stretch releasing the optical pressure sensitive adhesive and the device can be re-laminated to provide a defect-free lamination. Also, over the lifetime of the device, if it is desirable to remove the rigid cover sheet for replacement or recycling, the rigid cover can be removed by stretch releasing the optical pressure sensitive adhesive. Such removal is not possible with curing optical adhesives and is very difficult even with pressure sensitive adhesives.

In some illustrative embodiments, adhesive articles are provided that include an optical film and a pressure sensitive adhesive film adjacent to at least one major surface of the optical film. The adhesive articles can further include another substrate (e.g., permanently or temporarily attached to the pressure sensitive adhesive layer), another adhesive layer, or a combination thereof. As used herein, the term “adjacent” can be used to refer to two layers or films that are in direct contact or that are separated by one or more layers or films. Often, adjacent layers or films are in direct contact.

In some embodiments, the resulting articles can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, screens or displays, cathode ray tubes, polarizers, reflectors, touch sensors and the like.

Any suitable optical film can be used in the articles. As used herein, the term “optical film” refers to a film that can be used to produce an optical effect. The optical films are typically polymer-containing films that can be a single layer or multiple layers. The optical films are flexible and can be of any suitable thickness. The optical films often are at least partially transmissive, reflective, antireflective, polarizing, optically clear, or diffusive with respect to some wavelengths of the electromagnetic spectrum (e.g., wavelengths in the visible ultraviolet, or infrared regions of the electromagnetic spectrum). Exemplary optical films include, but are not limited to, visible mirror films, color mirror films, solar reflective films, infrared reflective films, ultraviolet reflective films, reflective polarizer films such as a brightness enhancement films and dual brightness enhancement films, absorptive polarizer films, optically clear films, tinted films, and antireflective films.

In some embodiments the optical film has a coating. In general, coatings are used to enhance the function of the film or provide additional functionality to the film. Examples of coatings include, for example, hardcoats, anti-fog coatings, anti-scratch coatings, privacy coatings or a combination thereof. Coatings such as hardcoats, anti-fog coatings, and anti-scratch coatings that provide enhanced durability, are desirable in applications such as, for example, touch screen sensors, display screens, graphics applications and the like. Examples of privacy coatings include, for example, blurry or hazy coatings to give obscured viewing or louvered films to limit the viewing angle.

Some optical films have multiple layers such as multiple layers of polymer-containing materials (e.g., polymers with or without dyes) or multiple layers of metal-containing material and polymeric materials. Some optical films have alternating layers of polymeric material with different indexes of refraction. Other optical films have alternating polymeric layers and metal-containing layers. Exemplary optical films are described in the following patents: U.S. Pat. Nos. 6,049,419, 5,223,465, 5,882,774, 6,049,419, RE 34,605, 5,579,162, and 5,360,659.

The substrate included in the article can contain polymeric materials, glass materials, ceramic materials, metal-containing materials (e.g., metals or metal oxides), or a combination thereof. The substrate can include multiple layers of material such as a support layer, a primer layer, a hard coat layer, a decorative design, and the like. The substrate can be permanently or temporarily attached to an adhesive film. For example, a release liner can be temporarily attached and then removed for attachment of the adhesive film to another substrate.

The substrate can have a variety of functions such as, for example, providing flexibility, rigidity, strength or support, reflectivity, antireflectivity, polarization, or transmissivity (e.g., selective with respect to different wavelengths). That is, the substrate can be flexible or rigid; reflective or non-reflective; visibly clear, colored but transmissive, or opaque (e.g., not transmissive); and polarizing or non-polarizing.

Exemplary substrates include, but are not limited to, the outer surface of an electronic display such as liquid crystal display or a cathode ray tube, the outer surface of a window or glazing, the outer surface of an optical component such as a reflector, polarizer, diffraction grating, mirror, or lens, another film such as a decorative film or another optical film, or the like.

Representative examples of polymeric substrates include those that contain polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes and polypropylenes, polyvinyl chlorides, polyimides, cellulose triacetates, acrylonitrile-butadiene-styrene copolymers, and the like.

In other embodiments, the substrate is a release liner. Any suitable release liner can be used. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048. The liner can have a microstructure on its surface that is imparted to the adhesive to form a microstructure on the surface of the adhesive film. The liner can then be removed to expose an adhesive film having a microstructured surface. The release liners can be printed with lines, brand indicia, or other information.

The thickness of the adhesive layer tends to be at least about 20 micrometers and is often no greater than about 1,500 micrometers. In some embodiments the thickness can be 25 to 1,270 micrometers, 50 to 1,000 micrometers, or 100 to 750 micrometers. The presently preferred thickness of a pressure-sensitive adhesive layer is from about 25 micrometers to about 300 micrometers,

The backing layer may be of any suitable construction. For example, the backing layer can be in the form of a foam, a film, or a combination thereof with any suitable thickness, composition, and opaqueness or clarity. The backing layer can be a single layer of film, a single layer of foam, multiple layers of film, multiple layers of foam, or multiple layers of foam and film.

The backing layer for the adhesive article is usually selected to have suitable mechanical properties for use in a stretch release adhesive tape. For example, the backing layer is selected so that it can be stretched (elongated) in a first direction (e.g., a lengthwise direction) at least 50 percent without breaking. That is, at least one dimension such as the length of the backing layer can be increased through stretching at least 50 percent without breaking. In some embodiments, the backing layer can be stretched at least 100 percent, at least 150 percent, at least 200 percent, at least 300 percent, at least 400 percent, or at least 500 percent without breaking. The backing layer can often be stretched up to 1200 percent, up to 1000 percent, up to 800 percent, up to 750 percent, or up to 700 percent without breaking. These relatively large elongation values facilitate stretch releasing of the adhesive article after being adhered to an object and/or substrate.

The Young's Modulus of the backing layer can be an indicator of the resistance of the backing layer to stretching. In certain embodiments, the Young's modulus of the backing layer may be no greater than 75,000 psi (about 520 MPa), no greater than about 50,000 psi (about 345 MPa), no greater than 25,000 psi (about 170 MPa), no greater than 10,000 psi (about 70 MPa), no greater than 5,000 psi (about 3.4 MPa), no greater than 1,000 psi (about 7 MPa), or no greater than 500 psi (about 3.4 MPa). For some film backing layers such as those described below that contain a poly(alkylene) copolymer, the Young's Modulus is often in the range of about 10 MPa to about 75 MPa. For example, the Young's Modulus can be in the range of 20 to 75 MPa, in the range of 20 to 60 MPa, in the range of 20 to 50 MPa, or in the range of 25 to 50 MPa. The Young's Modulus can be measured, for example, using method ASTM D790-07 or ASTM D882-02.

In many applications, the foam or film backing layers are prepared from a polymeric material such as, for example, a polyolefin (e.g., polyethylene such as high density polyethylene, low density polyethylene, linear low density polyethylene, and linear ultra low density polyethylene, polypropylene, and polybutylene), vinyl copolymers (e.g., polyvinyl chloride and polyvinyl acetates), olefinic copolymers (e.g., ethylene/methylacrylate copolymers, ethylene/vinyl acetate copolymers, and ethylene/propylene copolymers), acrylonitrile-butadiene-styrene copolymers, acrylic polymers and copolymers, polyurethanes, and combinations or blends thereof. Exemplary blends include polypropylene/polyethylene blends, polyurethane/polyolefin blends, polyurethane/polycarbonate blends, and polyurethane/polyester blends.

Other suitable blends may include, for example, blends of thermoplastic polymers, elastomeric polymers and combinations thereof. Suitable blends can include, for example, styrene-butadiene copolymers, polychloroprenes (i.e., neoprene), nitrile rubbers, butyl rubbers, polysulfide rubbers, cis-1,4-polyisoprenes, ethylene-propylene terpolymers (e.g., EPDM rubber), silicone rubbers, silicone polyurea block copolymers, polyurethane rubbers, natural rubbers, acrylate rubbers, thermoplastic rubbers (e.g., styrene-butadiene block copolymers and styrene-isoprene-styrene block copolymers), thermoplastic polyolefin rubber materials, and combinations thereof.

In some embodiments, the backing layer is a film that contains a poly(alkylene) copolymer that is derived from at least two different alkene monomers. The poly(alkylene) copolymer is typically the reaction product of an alkene mixture that includes 1) a first alkene selected from ethene, propene, or a mixture thereof and 2) a second alkene monomer selected from a 1,2-alkene having 4 to 8 carbon atoms. For example, the second alkene monomer often has four, six, or eight carbon atoms. That is, the alkene mixture includes 1) ethene, propene, or a mixture thereof and 2) butene, hexene, octene, or a mixture thereof. These copolymers are typically prepared using a metallocene catalyst. Mixtures or combinations of these copolymers may also be used.

A useful foam backing layer is typically conformable and assists in increasing the degree of surface contact between the pressure-sensitive adhesive layer disposed thereon and the surface of the substrate. The foam layer preferably is capable of achieving from about 50 percent to about 600 percent elongation (i.e., the foam layer is stretchable at least 50 percent to 600 percent). The elongation at break is preferably sufficiently high so that the backing layer remains intact during removal of the adhesive tape from a substrate to which it has been adhered.

The foam backing layers are often selected to optimize properties such as conformability and resiliency. Conformable and resilient polymeric foams are well suited for applications in which the adhesive article is to be adhered to substrates having surface irregularities. The foam layer usually has a density of at least about 2 pounds per cubic foot (pcf), at least about 6 pcf, at least about 8 pcf, or at least about 12 pcf, less than about 30 pcf, less than about 25 pcf, or even less than about 15 pcf. The foam layer can have any thickness suitable for the intended application. Suitable foam backing layers often have a thickness of at least 5 mils or at least 30 mils. The thickness can be up to 100 mils, up to 125 mils, up to 150 mils, or even greater. In some embodiments the foam layer includes multiple layers of foam and each layer of foam contributes a different property such as density, percent elongation, tensile strength, and combinations thereof.

Polymeric film backing layers can be in a variety of forms including, for example, a single-layer or multi-layer film, a porous film, and combinations thereof. The polymeric film may contain one or more fillers (e.g., calcium carbonate). The polymer film can be a continuous layer or a discontinuous layer. Multi-layer polymer films are preferably integrally bonded to one another in the form of a composite film, a laminate film, and combinations thereof. Multilayer polymeric films can be prepared using any suitable method including, for example, co-molding, coextruding, extrusion coating, joining through an adhesive, joining under pressure, joining under heat, and combinations thereof.

A film layer of a backing can be bonded to a layer of foam using any suitable mechanism including, for example, coextruding the film and the foam layer, co-molding, extrusion coating, joining through an adhesive composition, joining under pressure, joining under heat, and combinations thereof. Any suitable adhesive compositions for bonding a film layer to the foam layer can be used. Where only one polymeric film or foam layer of a multi-layer backing is intended to be stretched to effect debonding, that layer should exhibit sufficient physical properties and be of a sufficient thickness to achieve that objective.

In embodiments where the backing layer includes at least a foam layer and a film layer, the film layer may contain a poly(alkylene) copolymer that is derived from at least two different alkene monomers. The poly(alkylene) copolymer is typically the reaction product of an alkene mixture that includes 1) a first alkene selected from ethene, propene, or a mixture thereof and 2) a second alkene monomer selected from a 1,2-alkene having 4 to 8 carbon atoms. For example, the second alkene monomer often has four, six, or eight carbon atoms. That is, the alkene mixture includes 1) ethene, propene, or a mixture thereof and 2) butene, hexane, octane, or a mixture thereof. These copolymers are typically prepared using a metallocene catalyst. Mixtures or combinations of these copolymers may also be used.

In some applications, the backing layers (if present), the adhesive layers, and the resulting stretch releasable adhesive article are optically clear. As used herein, the term “optically clear” refers to a backing layer, an adhesive layer, or an adhesive article that has a luminous transmission of at least 90 percent and a haze no greater than 5 percent as measured using the method ASTM D1003-07. With this method, measurements are made in the 400 to 700 nanometer wavelength range. The luminous transmission is often equal to at least 91 percent, at least 92 percent, at least 93 percent, at least 94 percent, or least 95 percent. The haze is often no greater than 4, no greater than 3, no greater than 2, or no greater than 1.

Some exemplary adhesive articles 8 have a haze no greater than 3 percent and a luminous transmission equal to at least 90 percent as measured using method ASTM D1003-07. Other exemplary adhesive articles 8 have a haze no greater than 2 percent and a luminous transmission equal to at least 90 percent as measured using method ASTM D1003-07. Not all materials that are visibly clear are considered to be optically clear. That is, visible clarity is not always synonymous with optical clarity. A material that is visibly clear can have a haze value greater than 5, a luminous transmission value less than 90 percent, or both.

In some end-use applications, the optically clear, stretch releasable adhesive article can be positioned between two substrates such that the second substrate is visible when viewed through both the first substrate and the optically clear adhesive article. If the adhesive article is optically clear, the second substrate often can be viewed by looking through the first substrate and the adhesive article. The optically clear adhesive article may be used to couple a first substrate such as an optically clear substrate (e.g., a cover lens) to a second substrate such as a display (e.g., a liquid crystal display). If the adhesive coupling formed by the adhesive article is adequate, the optically clear adhesive article remains positioned between the first substrate and the display. If the coupling is defective, however, or if the one of the substrate or display is damaged and a user wishes to separate the substrate from the display, the adhesive article can be removed from the substrate and display, without damaging either, by stretching. The adhesive article can then be replaced, and the first substrate and the display can be coupled again with another optically clear, stretch releasable adhesive article.

Optically clear backing layers are used to prepare optically clear adhesive tapes. In many embodiments, the optically clear backing layers contain poly(alkylene) copolymers prepared from an alkene mixture that includes 1) a first alkene selected from ethene, propene, or a mixture thereof and 2) a second alkene monomer selected from a 1,2-alkene having 4 to 8 carbon atoms. Many poly(alkylene) copolymers with suitable mechanical properties for use as a backing layer, however, do not have low haze (i.e., no greater than 5 percent as measured using method ASTM D1003-07) and high luminous transmission (i.e., at least 90 luminous transmission as measured using ASTM D1003-07) that is usually needed to prepare an optically clear backing layer for use in an optically clear adhesive tape. For example, the relatively large crystalline size of many poly(alkylene) copolymers, the use of various additives in many commercially available poly(alkylene) copolymers, and the specific methods used to form films of the poly(alkylene) copolymer can make then unsuitable for use as an optically clear backing layer.

If an optically clear backing is desired, the poly(alkylene) copolymer preferably has some crystalline material rather than being completely amorphous. The crystalline material tends to add strength to the backing layer by functioning as a physical crosslinker. If the size of the crystalline material is too large, however, the haze of the backing layer can be unacceptably large. The crystalline material preferably has a size that is less than a wavelength of visible light. In many embodiments of suitable poly(alkylene) copolymers, at least 95 percent of the crystalline material has a crystalline size less than 400 nanometers. For example, at least 95 percent of the crystalline material can have a crystalline size less than 300 nanometers, less than 200 nanometers, or less than 100 nanometers. A small crystalline size facilitates the formation of a backing layer that is optically clear.

Backing layers with crystalline material smaller than 400 nanometers can be prepared using various methods. In one method, the poly(alkylene) copolymers used to form the backing layer are melted, extruded, and quenched rapidly so that the alignment and growth of the crystals is minimized. In another method, seed materials (i.e., nucleating agents) can be added that facilitate the formation of many crystals within the copolymer upon cooling to form the solidified film. The formation of more crystals tends to favor smaller crystalline sizes.

In yet another method, the copolymer composition is varied to alter the crystalline size. A greater amount of the second alkene monomer having 4 to 8 carbon atoms tends to result in smaller crystalline size. The density or specific gravity tends to decrease as the amount of the second alkene monomer increases. The specific gravity is often no greater than 0.91. For example, the specific gravity is often no greater than 0.90 or no greater than 0.89. The specific gravity is often in the range of 0.86 to 0.91, in the range of 0.87 to 0.90, or in the range of 0.88 to 0.90.

If optical clarity is desired, the backing layer preferably is free or substantially free of additives that contribute haze or that lower the luminous transmission. For example, the backing layer typically does not include an anti-blocking agent, a slip agent, or both. That is, the backing layer is usually free or substantially free of an anti-blocking agent, slip agent, or both.

As used herein, the term “substantially free” with reference to the anti-blocking agent or to the slip agent means that these agents are each present in an amount no greater than 0.5 weight percent, no greater than 0.3 weight percent, no greater than 0.2 weight percent, no greater than 0.1 weight percent, no greater than 0.05 weight percent, or no greater than 0.01 weight percent.

Anti-blocking agents are often added when films are prepared from poly(alkylene) copolymers to prevent the film from sticking to itself such as when formed into a roll. Exemplary anti-blocking agents include, but are not limited to, particles such as diatomaceous earth and talc. Slip agents are often added to reduce friction such as film-to-film friction in a roll or film-to-production equipment friction. The presence of these slip agents also can interfere with good adhesion to the at least one pressure-sensitive adhesive layer. Many commonly used slip agents are primary amides such as those made from long chain fatty acids by amidation. Examples of slip agents include, but are not limited to, stearamide, oleamide, and erucamide.

In many embodiments where optical clarity is desired, the backing layer contains at least 99 percent poly(alkylene) copolymer. For example, the backing layer contains at least 99.1 weight percent, at least 99.2 weight percent, at least 99.3 weight percent, at least 99.4 weight percent, at least 99.5 weight percent, at least 99.6 weight percent, at least 99.7 weight percent, at least 99.8 weight percent, at least 99.9 weight percent poly(alkylene) copolymer.

Exemplary poly(alkylene) copolymers that can be used to prepare optically clear backing layers are commercially available under the trade designation EXACT (e.g., EXACT 3024, 3040, 4011, 4151, 5181, and 8210) and VISTAMAXX (e.g., VISTAMAXX 6202 and 3000) from ExxonMobile Chemical (Houston, Tex.). Other exemplary poly(alkylene) copolymers are commercially available under the trade designations AFFINITY (e.g., AFFINITY PT 1845G, PL 1845G, PF 1140G, PL 1850G, and PL 1880G), ENGAGE (e.g., ENGAGE 8003), and INFUSE (e.g., INFUSE D9530.05) from Dow Chemical (Midland, Mich.). EXACT 8210, EXACT 5181, ENGAGE 8003, and INFUSE D9530.05, are ethylene-octene copolymers. EXACT 3040 and EXACT 4151 are ethylene-hexene copolymers. EXACT 3024 and EXACT 4011 are ethylene-butene copolymers.

Exemplary film backing layers formed from poly(alkylene) copolymers that are not optically clear are available under the trade designations XMAX and MAXILENE series of trade designations (e.g., MAXILENE 200 is an ethylene-octene copolymer that is not prepared with a metallocene catalyst) from Pliant Corporation (Chippewa Falls, Wis.). These backing layers can be used to produce adhesive tapes that are visibly clear but not optically clear, slightly hazy, or opaque. These films often contain a slip agent, an anti-blocking agent, or both.

In addition to choosing suitable materials that will result in backing layers with low haze and high luminous transmission, the method of preparing the backing layer must be selected to maintain these values if optical clarity is desired. That is, the method of making the backing layer is typically selected to provide a smooth surface and a relatively uniform thickness. If the surface is roughened, the percent haze may become undesirably large. To provide suitable optical clarity, a process is often selected to provide a thickness that is relatively uniform across the backing layer in any direction. For example, the thickness varies by less than 10 percent, less than 8 percent, less than 6 percent, less than 5 percent across the backing layer in any direction. More specifically, a backing layer having an average thickness of 4 mils (0.1 millimeter or 100 micrometers) has a thickness variation of less than 10 micrometers, less than 8 micrometers, less than 6 micrometers, or less than 5 micrometers across the backing layer in any direction.

If optically clear backing layers are desired, many conventional methods used to form films of poly(alkylene) copolymers are not suitable because the resulting films do not have the requisite smoothness. For example, blowing methods are usually not suitable because anti-blocking agents or slip agents are frequently added. The addition of these agents often tends to roughen the surface of the resulting film. Cast extrusion methods that impart a rough surface to the film in an attempt to minimize contact with a chill roller are typically not suitable. These methods can be used, however, to prepare backing layers when optical clarity is not a concern.

Various methods can be used to prepare backing layers with suitable smoothness and thickness uniformity when optical clarity is desired. In a first example, the poly(alkylene) copolymer can be cast between two smooth support layers such as release liners or between a smooth support layer and a smooth roller. No blocking agent or slip agent is needed and the absence of these agents is preferred. The support layer (e.g., release liner) tends to reinforce the resulting rubbery backing layer and allows the backing layer to be subjected to further processing without distortion or stretching. Further, the support layer tends to protect the surface of the backing layer until it is combined with the at least one pressure-sensitive adhesive layer.

More specifically, the poly(alkylene) copolymer can be extruded as a molten film using, for example, a flat cast extrusion die. The extrusion temperature can be in the range of about 150° C. to 275° C. The extruded film of poly(alkylene) copolymer can be extruded between two support films. The resulting construction of support film/poly(alkylene) copolymer film/support film can then be passed through a chilled roll stack to cool and solidify the poly(alkylene) copolymer film. Backing films that are prepared using this method tend to have a relatively uniform thickness and tend to be relatively smooth. The support films are often release liners. Suitable support films, such as conventional PET film or release liners, may be used during the preparation of the backing film layer. The support films are typically easily removed after preparation of the backing layer without stretching or damaging the backing film layer.

The thickness of a film-based backing layer is often selected by balancing the desired load bearing strength and rupture strength against the stretch release force. A greater stretch release force is usually needed as the thickness of the backing layer is increased. Conversely, a lower stretch release forces is needed as the thickness of the backing layer is decreased. The thickness of a film-based backing layer can be, for example, up to 40 mils (1.0 millimeter or 1000 micrometers). As used herein, the term “mil” refers to 0.001 inch and 1 mil is equal to about 0.0025 centimeters or about 0.025 millimeters or about 25 micrometers.

In many embodiments, the thickness is up to 30 mils (750 micrometers), up to 20 mils (500 micrometers), up to 10 mils (250 micrometers), up to 8 mils (200 micrometers), up to 6 mils (150 micrometers), or up to 5 mils (125 micrometers). The thickness is often at least 1 mil (0.025 millimeters or 25 micrometers), at least 2 mils (50 micrometers), at least 3 mils (75 micrometers), or at least 4 mils (100 micrometers). Some suitable backing layers have a thickness in the range of 1 mil (25 micrometers) to 20 mils (500 micrometers), in the range of 1 mil (25 micrometers) to 10 mils (250 micrometers), in the range of 1 mil (25 micrometers) to 8 mils (200 micrometers), in the range of 1 mil (25 micrometers) to 7 mils (175 micrometers), in the range of 2 mils (50 micrometers) to 8 mils (200 micrometers), in the range of 3 mils (75 micrometers) to 6 mils (150 micrometers), or in the range of 4 mils (100 micrometers) to 5 mils (125 micrometers).

As prepared, the backing layer is usually a rubbery material and can be slightly tacky. A pressure-sensitive adhesive layer is positioned adjacent to at least one major surface of the backing layer. In many embodiments, a first pressure-sensitive adhesive layer is positioned adjacent to a first major surface of the backing layer and a second pressure-sensitive adhesive layer is positioned adjacent to a second major surface of the backing layer. The second major surface of the backing layer is the surface opposite the first major surface. As used with reference to the pressure-sensitive adhesive layer and the backing layer, the term “adjacent” means that the pressure-sensitive adhesive layer contacts the backing layer or is separated from the backing layer by one or more intervening layers. That is, each pressure-sensitive adhesive layer is adhered directly or indirectly to the backing layer. The intervening layer is often a primer layer or a layer resulting from a priming treatment.

The backing layer may be subjected to a priming treatment prior to being positioned adjacent to the at least one pressure-sensitive adhesive layer. The primer treatment tends to increase adhesion between the backing layer and the pressure-sensitive adhesive layer. This increased adhesion is often desirable for a stretch releasing adhesive tape. That is, it is usually desirable that the adhesion of the pressure-sensitive adhesive layer to the backing layer is stronger than the adhesion of the pressure-sensitive adhesive layer to the substrate. Any suitable priming treatment known in the art can be used. For example, the priming treatment can include treatment with a chemical primer composition, treatment with a corona discharge or plasma discharge, exposure to an electron beam or ultraviolet light, acid etching, or combinations thereof.

In some embodiments, the primer treatment includes applying a primer composition to a surface of the backing layer. Any suitable primer composition can be used. The primer composition can include, for example, a reactive chemical adhesive promoter (e.g., the components can react with the backing layer, the adhesive layer, or both). Exemplary primer compositions include those described in U.S. Pat. No. 5,677,376 (Groves), incorporated herein by reference in its entirety. That is, the primer composition can include a blend of (1) a block copolymer such as styrene-ethylene/butylene-styrene block copolymer that is modified with maleic acid or maleic anhydride and (2) the polymeric reaction product of monovalent monomer mixture that includes (a) at least one alkyl (meth)acrylate ester of a non-tertiary alcohol having 1 to 14 carbon atoms and (b) at least one nitrogen-containing monomer. The block copolymer can be, for example, those commercially available from Shell Chemical Co. under the trade designation KRATON FG-1901X. Other suitable primer compositions include those commercially available under the trade designation NEOREX (NEOREX R551) from

The optically clear, stretch releasable adhesive tape can be positioned between two substrates such that the second substrate is visible when viewed through both the first substrate and the optically clear adhesive tape. For example, the optically clear adhesive tape can be used to couple a first substrate such as a optically clear substrate to a second substrate such as a display (e.g., a liquid crystal display). If the coupling is not defective, the optically clear adhesive tape remains positioned between the first substrate and the display. If the coupling is defective, however, the adhesive tape can be removed without damaging the display. The adhesive tape can be replaced and the first substrate and the display can be coupled again with another optically clear, stretch releasable adhesive tape.

In another aspect, an optically clear, stretch releasable adhesive tape is provided. The adhesive tape includes an optically clear carrier film having a first surface and a second surface that is opposite the first surface. A first optically clear adhesive layer is adjacent to the first surface of the carrier film and a second optically clear adhesive layer is adjacent to the second surface of the carrier film. The carrier film contains a polyalkylene copolymer derived from ethylene and a second alkylene monomer having four, six, or eight carbon atoms. The carrier film contains crystalline material and at least 95 percent of the crystalline material has a crystalline size less than 400 nanometers.

The adhesive tape is a dual-sided adhesive tape with a carrier film positioned between two adhesive layers. The carrier film and each of the adhesive layers is optically clear. The luminous transmission is often at least 92 percent, at least 94 percent, at least 95 percent, at least 96 percent, at least 97 percent, at least 98 percent, or at least 99 percent. The haze is often no greater than 4, no greater than 3, no greater than 2, or no greater than 1. Both the luminous transmission and the haze can be determined using, for example, ASTM-D 1003-95. Not all materials that are visibly clear are considered to be optically clear. That is, visible clarity is not always synonymous with optical clarity. A material that is visibly clear can have a haze value greater than 5, a luminous transmission value less than 90 percent, or both.

The adhesive tape may, in some illustrative embodiments, be stretch releasing. The adhesive tape can be adhered to two substrates (i.e., the adhesive tape can be positioned between the two substrates) and then released from both substrates by stretching the carrier film and the adhesive layers of the adhesive tape. After being released, the adhesive tape can be removed from between the two substrates. The substrates can be separated from each other. For example, the adhesive tape can be released by stretching in the event that the coupling of the two substrates is defective. The coupling can be defective, for example, because the first substrate is not properly aligned with the second substrate or a bubble is trapped between the two substrates. Typically, the stretch releasing adhesive tape can be cleanly removed from between the substrates with little or no visible adhesive residue remaining on either substrate. Additionally, the stretch releasing adhesive tape usually can be removed without damaging the appearance, function, or performance of either substrate.

Releasing the adhesive tape includes pulling on or stretching an optional tab of the adhesive tape. The tab extends beyond the substrates. That is, the substrates do not contact the adhesive tape in the region of the tab. The tab is pulled in a direction that is parallel or substantially parallel to the substrates. That is, the tab is pulled in a direction that is 0 degrees, less than 5 degrees, less than 10 degrees, less than 15 degrees, less than 20 degrees, less than 25 degrees, less than 30 degrees, or less than 35 degrees from the substrates. The tab often includes the carrier film. In some embodiments, the tab is formed from a second region of the carrier film that extends beyond a first region of the carrier film that is in contact with the optically clear adhesive layers. The tab is non-tacky in these embodiments. In other embodiments, the tab includes the carrier film and at least one of the adhesive layers. The tab is tacky in these embodiments. The adhesive layers and the carrier films of the adhesive tapes are typically both highly extensible. The adhesive layers and the carrier films can be stretched without breaking or snapping under the stretch releasing conditions. The adhesive layers usually do not separate from the carrier film during stretching and have higher cohesion than adhesion to the substrates.

Various unexpected results and advantages are obtained in the various illustrative embodiments of the present disclosure. In certain illustrative embodiments, the adhesive article is optically clear, and preferably has a visible light transmission of at least about 90%, and a haze of no greater than 5%. In further such embodiments, the adhesive of the adhesive article is self-wetting to the end-use substrate. In additional such embodiments, the adhesive article is extensible, and is stretch releasable. In certain presently-preferred embodiments, the adhesive article exhibits a 180° PEEL ADHESION to a glass substrate no greater than about 500 N/dm after aging for seven days at 85° C.

The silicone-based adhesive compositions and adhesive articles of the present disclosure will be further described with regard to the following illustrative Examples. It should be understood, however, that many variations and modifications may be made while remaining within the scope of the present disclosure.

### EXAMPLES

These examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Summary of Materials

Unless otherwise noted, all parts, percentages, ratios, etc. in the Examples and the rest of the specification are by weight. Solvents and other reagents used may be obtained from Sigma-Aldrich Chemical Company (Milwaukee, Wis.) unless otherwise noted. In addition, Table 1 provides abbreviations and a source for all materials used in the examples below:

TABLE 1
Materials

| Abbreviation | Description | Source |
|---|---|---|
| PDMS diamine 20k | Polydimethylsiloxane diamine; | Prepared as described in |
| | Approximately 22,000 g/mole | Example 2 of U.S. Pat. |
| | molecular weight | No. 5,461,134 (Leir et al.) |
| PDMS diamine 33k | Polydimethylsiloxane diamine; | Prepared as described in |
| | Approximately 33,000 g/mole | Example 2 of U.S. Pat. |
| | molecular weight | No. 5,461,134 (Leir et al.) |
| MQ Resin 1 | A 60 wt. % solids solution of MQ | GE Silicones, Waterford, |
| | silicate resin in toluene, | NY |
| | commercially available from GE | |
| | Silicones under the trade designation | |
| | “SR-545” | |
| MQ Resin 2 | A solid MQ tackifying resin, ~ 1.5% | Wacker Chemie AG, |
| | hydroxyl, available from Wacker | Munchen, Germany |
| | Chemie AG under the trade | |
| | designation “WACKER 803-TF”, | |
| | used as the solid | |
| MQ Resin 3 | A 62.9 wt. % solids solution of MQ | Dow Corning, Midland, |
| | silicate resin in xylene, commercially | MI |
| | available from Dow Corning, under | |
| | the trade designation “2-7066”. | |
| DYTEK A | 2-Methylpentamethylenediamine, | E. I. du Pont de Nemours |
| | available from DuPont Chemical, | and Company, |
| | Wilmington, DE under the trade | Wilmington, DE |
| | designation “DYTEK A” | |
| H-MDI | Methylenedicyclohexylene-4,4′- | Bayer Corporation, |
| | diisocyanate, commercially available | Pittsburgh, PA |
| | under the trade designation | |
| | “DESMODUR W H₁₂-MDI” from | |
| | Bayer Corporation, Pittsburgh, PA | |
| HOSTAPHAN | A Polyethylene terephthalate (PET) | Mitsubishi Polyester Film, |
| 3SAB | film, ~2 mils (~51 micrometers) | Inc., Greer, SC |
| | thick, available from Mitsubishi | |
| | Polyester Film under the trade | |
| | designation “HOSTAPHAN 3SAB” | |

### Test Methods

The following test methods have been used in evaluating some of the examples of the present disclosure.

### 180° Peel Adhesion Test

The 180 degree (180°) peel adhesion test was carried out according to ASTM D 3330-90, except that a glass substrate (i.e., window glass) was substituted for the stainless steel substrate described in the test.

Unless otherwise noted, adhesive coatings on polyester film were cut into 1.27 centimeter by 15 centimeters strips. Each strip was then adhered to a 10 centimeters by 20 centimeters clean, solvent washed, glass coupon using a 2-kilogram roller passed once over the strip. The 180° peel adhesion was measured using an IMASS slip/peel tester (MODEL 3M90, commercially available from Instrumentors Inc., Strongsville, Ohio) at a rate of 2.3 meters/minute (90 inches/minute) over a five second data collection time. Two samples were tested; the reported peel adhesion value was an average of the peel adhesion value from each of the two samples. Peel adhesion values were recorded in grams/inch and converted to Newtons per decimeter (N/dm).

### Haze and Transmission

Haze and transmission of illustrative adhesive articles were measured with a BYK Gardner Spectrophotometer according to ATM D1003-1995. The measurement was reported as the A2* value, which represents the haze under the light of a tungsten filament lamp.

### PREPARATIVE EXAMPLES

The following illustrate Preparative Examples of various elastomer solutions used in the preparation of silicone adhesives according to the present disclosure.

### Elastomer A Solution

A 20 weight percent (wt. %) solids elastomer solution in a mixture of 75/25 (wt/wt) toluene/2-propanol was prepared. The elastomer was a copolymer of PDMS diamine 20k/DYTEK A/H-MDI in a molar ratio of 1/1/2, as summarized in Table 2.

### Elastomer B Solution

A 20 wt. % solids elastomer solution in a mixture of 75/25 (wt/wt) toluene/2-propanol was prepared. The elastomer was a copolymer of PDMS diamine 33k/DYTEK A/H-MDI in a molar ratio of 1/1/2, as summarized in Table 2.

### Elastomer C Solution

A 20 wt. % solids elastomer solution in a mixture of 65/35 (wt/wt) toluene/2-propanol was prepared. The elastomer was a copolymer of PDMS diamine 33k/DYTEK A/H-MDI in a molar ratio of 1/0.5/1.5, as summarized in Table 2.

TABLE 2
Silicone Elastomer Solutions

| | PDMS | PDMS | | | |
|---|---|---|---|---|---|
| | diamine | diamine, | DYTEK-A, | H₁₂MDI, | Wt. % |
| Sample | MW (Da) | mols | mols | mols | solids |
| Elastomer A | 20k | 1 | 1 | 2 | 20 |
| solution | | | | | |
| Elastomer B | 33k | 1 | 1 | 2 | 20 |
| solution | | | | | |
| Elastomer C | 33k | 1 | 0.5 | 1.5 | 20 |
| solution | | | | | |

### Examples of Silicone Adhesive Compositions

The following illustrate Examples of the preparation of various silicone adhesives according to the present disclosure, as well as Comparative Examples.

### Examples 1 to 12 (EX-1 to EX-12)

### Adhesives Including Elastomer A and an MQ Resin

For each of EX-1 to EX-12, an adhesive coating solution was prepared by weighing a sample of Elastomer A solution and a sample of an MQ resin into ajar, using the type of MQ resin and amounts summarized in Table 3. The jar was placed on a roller and the contents were mixed overnight at ambient temperature to provide an adhesive coating solution. Comparative Example 1 (CE-1) included only Elastomer A and no MQ resin.

TABLE 3
Silicone Adhesive Compositions

| | Elastomer A | | MQ | |
|---|---|---|---|---|
| | (grams of | | Resin, | |
| Example # | solution) | MQ Resin | (grams)* | Wt. % MQ |
| CE-1 | 50.00 | none | 0 | 0 |
| EX-1 | 55.20 | MQ Resin 1 | 0.80 | 5 |
| EX-2 | 52.60 | MQ Resin 1 | 1.61 | 10 |
| EX-3 | 50.00 | MQ Resin 1 | 2.43 | 15 |
| EX-4 | 47.93 | MQ Resin 1 | 3.30 | 20 |
| EX-5 | 55.10 | MQ Resin 2 | 0.58 | 5 |
| EX-6 | 52.65 | MQ Resin 2 | 1.17 | 10 |
| EX-7 | 49.85 | MQ Resin 2 | 1.76 | 15 |
| EX-8 | 47.40 | MQ Resin 2 | 2.37 | 20 |
| EX-9 | 55.20 | MQ Resin 3 | 0.83 | 5 |
| EX-10 | 52.60 | MQ Resin 3 | 1.67 | 10 |
| EX-11 | 49.97 | MQ Resin 3 | 2.52 | 15 |
| EX-12 | 47.88 | MQ Resin 3 | 3.42 | 20 |

*MQ Resin 1 and MQ Resin 3 were obtained as solutions and were used as received, in the amounts given in Table 3 for grams of as-received solution. MQ Resin 2 was obtained as a solid, and was used as such (i.e., MQ Resin 2 was added as a solid).

Samples of the adhesive coating solutions of EX-1 to EX-12 and CE-1 were knife coated onto 2 mil (˜51 micrometers) HOSTAPHAN 3SAB film, at a gap sufficient to yield a dry adhesive having a thickness of about 1 mil (˜25 micrometers). The coated film was dried for about 15 min. at 65° C. Film samples for each example were subject to one of the following conditions: room temperature (RT) for 10 minutes; RT for 7 days; 65° C. for 7 days; 85° C. for 7 days. Following the conditioning step, the samples were evaluated with the “180° PEEL ADHESION TEST”, with results as summarized in Table 4.

TABLE 4
180° PEEL ADHESION TEST [Results in grams/inch and (N/dm)]

| Ex- | RT for | RT for | 65° C. for | 85° C. for |
|---|---|---|---|---|
| ample # | 10 min | 7 Days | 7 Days | 7 Days |
| CE-1 | 8.5 (3.4) | 97.4 (39.1) | 911.4 (365.9) | 1862.6 (747.8) |
| EX-1 | 13.2 (5.3) | 25.1 (10.1) | 211.5 (84.9) | 225.4 (90.5) |
| EX-2 | 16.2 (6.5) | 28.8 (11.6) | 175.3 (70.4) | 160.9 (64.6) |
| EX-3 | 16.9 (6.8) | 38.8 (15.6) | 152.2 (61.1) | 150.1 (60.3) |
| EX-4 | 18.1 (7.3) | 89.3 (35.9) | 165.4 (66.4) | 217.6 (87.4) |
| EX-5 | 16.6 (6.7) | 87.6 (35.2) | 116.8 (46.9) | 358.6 (144.0) |
| EX-6 | 17.4 (7.0) | 106 (42.6) | 164.9 (66.2) | 423.8 (170.1) |
| EX-7 | 26.5 (10.6) | 111.7 (44.8) | 241.3 (96.9) | 337.4 (135.5) |
| EX-8 | 35.4 (14.2) | 163.3 (65.6) | 373.9 (150.1) | 601.0 (241.3) |
| EX-9 | 18 (7.2) | 92.6 (37.2) | 167.5 (67.2) | 924.2 (371.0) |
| EX-10 | 21.4 (8.6) | 95.6 (38.4) | 157.6 (63.3) | 771.1 (309.6) |
| EX-11 | 28.3 (11.4) | 109.9 (44.1) | 216.4 (86.9) | 1002.2 (402.3) |
| EX-12 | 78.1 (31.4) | 104.9 (42.1) | 281.9 (113.2) | 863.2 (346.5) |

### Examples 13 to 24 (EX-13 to EX-24)

### Adhesives Including Elastomer B and an MQ Resin

For each of EX-13 to EX-24, an adhesive coating solution was prepared by weighing a sample of Elastomer B solution and a sample of an MQ resin into ajar, using the type of MQ resin and amounts summarized in Table 5. The jar was placed on a roller and the contents were mixed overnight at ambient temperature to provide an adhesive coating solution. Comparative Example 2 (CE-2) included only Elastomer B and no MQ resin.

TABLE 5
Silicone Adhesive Compositions

| | Elastomer A | | | |
|---|---|---|---|---|
| | (grams of | | MQ Resin, | |
| Example # | solution) | MQ Resin | (grams)* | Wt. % MQ |
| CE-2 | 100.00 | none | 0 | 0 |
| EX-13 | 55.20 | MQ Resin 1 | 0.80 | 5 |
| EX-14 | 52.60 | MQ Resin 1 | 1.61 | 10 |
| EX-15 | 50.00 | MQ Resin 1 | 2.43 | 15 |
| EX-16 | 47.90 | MQ Resin 1 | 3.30 | 20 |
| EX-17 | 95.00 | MQ Resin 2 | 1.00 | 5 |
| EX-18 | 90.00 | MQ Resin 2 | 2.00 | 10 |
| EX-19 | 85.00 | MQ Resin 2 | 3.00 | 15 |
| EX-20 | 80.00 | MQ Resin 2 | 4.00 | 20 |
| EX-21 | 95.00 | MQ Resin 3 | 1.43 | 5 |
| EX-22 | 90.10 | MQ Resin 3 | 2.86 | 10 |
| EX-23 | 85.10 | MQ Resin 3 | 4.29 | 15 |
| EX-24 | 81.10 | MQ Resin 3 | 5.72 | 20 |

*MQ Resin 1 and MQ Resin 3 were obtained as solutions and were used as received, in the amounts given in Table 5 for grams of as-received solution. MQ Resin 2 was obtained as a solid, and was used as such (i.e., MQ Resin 2 was added as a solid).

Samples of the adhesive coating solutions of EX-13 to EX-24 and CE-2 were knife coated onto 2 mil (˜51 micrometers) HOSTAPHAN 3SAB film, at a gap sufficient to yield a dry adhesive having a thickness of about 1 mil (˜25 micrometers). The coated film was dried for about 15 min. at 65° C. Film samples for each example were subject to one of the following conditions: room temperature (RT) for 10 minutes; RT for 7 days; 65° C. for 7 days; 85° C. for 7 days. Following the conditioning step, the samples were evaluated with the “180° PEEL ADHESION TEST”, with results as summarized in Table 6.

TABLE 6
180° PEEL ADHESION TEST [Results in grams/inch and (N/dm)]

| | RT for | RT for | 65° C. for | 85° C. for |
|---|---|---|---|---|
| Example # | 10 min | 7 days | 7 Days | 7 days |
| CE-2 | 0 (0) | 45.1 (18.1) | 1136.8 (456.4) | 893 (358.5) |
| EX-13 | 18.9 (7.6) | 46.1 (18.5) | 175.6 (70.5) | 361.5 (145.1) |
| EX-14 | 25.4 (10.2) | 51.2 (20.6) | 128.7 (51.7) | 286.3 (114.9) |
| EX-15 | 40 (16.1) | 88.9 (35.7) | 237 (95.1) | 371.4 (149.1) |
| EX-16 | 57.1 (22.9) | 99.1 (39.8) | 325.3 (130.6) | 372.8 (149.7) |
| EX-17 | 8.9 (3.6) | 95.3 (38.3) | 169.4 (68.0) | 497.5 (199.7) |
| EX-18 | 27.6 (11.1) | 205.8 (82.6) | 237.9 (95.5) | 368.5 (147.9) |
| EX-19 | 32.6 (13.1) | 143.3 (57.5) | 304.8 (122.4) | 541.5 (217.4) |
| EX-20 | 67.5 (27.1) | 285.6 (114.7) | 307.6 (123.5) | 673.3 (270.3) |
| EX-21 | 15.9 (6.4) | 222.8 (89.4) | 620.9 (249.3) | 983.7 (394.9) |
| EX-22 | 33.5 (13.4) | 129.3 (51.9) | 737.1 (295.9) | 1050.3 (421.7) |
| EX-23 | 90.7 (36.4) | 129.7 (52.1) | 545.7 (219.1) | 1125.5 (451.8) |
| EX-24 | 114.4 (45.9) | 150.7 (60.5) | 423.8 (170.1) | 1013.5 (406.9) |

### Examples 25 to 32 (EX-25 to EX-32)

### Adhesives Including Elastomer C and an MQ Resin

For each of EX-13 to EX-24, an adhesive coating solution was prepared by weighing a sample of Elastomer C solution and a sample of an MQ resin into ajar, using the type of MQ resin and amounts summarized in Table 7. The jar was placed on a roller and the contents were mixed overnight at ambient temperature to provide an adhesive coating solution. Comparative Example 3 (CE-3) included only Elastomer C and no MQ resin.

TABLE 7
Silicone Adhesive Compositions

| | Elastomer A | | MQ | |
|---|---|---|---|---|
| | (grams of | | Resin, | |
| Example # | solution) | MQ Resin | (grams)* | Wt. % MQ |
| CE-3 | 70.00 | none | 0.00 | 0 |
| EX-25 | 66.50 | MQ Resin 2 | 0.70 | 5 |
| EX-26 | 63.00 | MQ Resin 2 | 1.40 | 10 |
| EX-27 | 59.50 | MQ Resin 2 | 2.10 | 15 |
| EX-28 | 56.00 | MQ Resin 2 | 2.80 | 20 |
| EX-29 | 66.50 | MQ Resin 3 | 1.00 | 5 |
| EX-30 | 63.00 | MQ Resin 3 | 2.00 | 10 |
| EX-31 | 59.50 | MQ Resin 3 | 3.00 | 15 |
| EX-32 | 56.00 | MQ Resin 3 | 4.00 | 20 |

*MQ Resin 1 and MQ Resin 3 were obtained as solutions and were used as received, in the amounts given in Table 7 for grams of as-received solution. MQ Resin 2 was obtained as a solid, and was used as such (i.e., MQ Resin 2 was added as a solid).

Samples of the adhesive coating solutions of EX-25 to EX-32 and CE-3 were knife coated onto 2 mil (8.1 micrometers) HOSTAPHAN 3SAB film, at a gap sufficient to yield a dry adhesive having a thickness of about 1 mil (˜25 micrometers). The coated film was dried for about 15 min. at 65° C. Film samples for each example were subject to one of the following conditions: room temperature (RT) for 10 minutes; RT for 7 days; 65° C. for 7 days; 85° C. for 7 days. Following the conditioning step, the samples were evaluated with the “180° PEEL ADHESION TEST”, with results as summarized in Table 8.

TABLE 8
180° PEEL ADHESION TEST [Results in grams/inch and (N/dm)]

| Ex- | RT for | RT for | 65° C. for | 85° C. for |
|---|---|---|---|---|
| ample # | 10 min | 7 days | 7 Days | 7 days |
| CE-3 | 15.9 (6.4) | 222.8 (89.4) | 620.9 (249.3) | 983.7 (394.9) |
| EX-25 | 23.2 (9.3) | 861.8 (346.0) | 1375.0 (552.0) | 1495.4 (600.3) |
| EX-26 | 33.0 (13.2) | 898.7 (360.8) | 1240.3 (497.9) | 1460 (586.1) |
| EX-27 | 53.2 (21.4) | 541.5 (217.4) | 1046.1 (420) | 1254.5 (503.6) |
| EX-28 | 102.9 (41.3) | 297.7 (119.5) | 551.4 (221.4) | 922.8 (370.5) |
| EX-29 | 17.3 (6.9) | 803.7 (322.7) | 1570.6 (630.5) | 1764.8 (708.5) |
| EX-30 | 32.7 (13.1) | 846.2 (339.7) | 1284.2 (515.6) | 1553.6 (623.7) |
| EX-31 | 81.8 (32.8) | 808.0 (324.4) | 1220.4 (489.9) | 1404.7 (563.9) |
| EX-32 | 140.9 (56.6) | 793.8 (318.7) | 1087.2 (436.5) | 1193.5 (479.1) |

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove.

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. An adhesive composition comprising:
an elastomeric silicone-based copolymer selected from the group consisting of urea-based silicone copolymers, oxamide-based silicone copolymers, amide-based silicone copolymers, urethane-based silicone copolymers, and mixtures thereof; and
greater than 0% by weight and no more than 20% by weight of MQ resin.

2. The adhesive composition of claim 1, comprising less than 10% by weight of MQ resin.

3. The adhesive composition of claim 1, wherein the elastomeric silicone-based copolymer comprises a urea-based silicone copolymer which is the reaction product of a polydiorganosiloxane diamine having a molecular weight of at least 5,000 grams/mole, and a polyisocyanate.

4. The adhesive composition of claim 1, wherein the elastomeric silicone-based copolymer comprises a urea-based silicone copolymer which is the reaction product of a polydiorganosiloxane diamine having a molecular weight of at least 5,000 g/mole, a polyamine, and a polyisocyanate.

5. The adhesive composition of claim 4, wherein the polyamine has a molecular weight no greater than about 300 g/mole.

6. The adhesive composition of claim 3, wherein the polydiorganosiloxane diamine has a molecular weight of from about 10,000 g/mole to about 65,000 g/mole.

7. The adhesive composition of claim 3, wherein the urea-based silicone copolymer is a silicone polyurea block copolymer comprising:
n blocks represented by the formula: 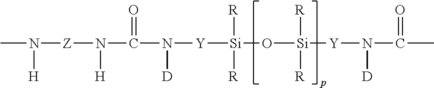
and m blocks represented by the formula: 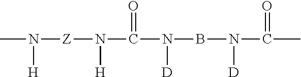
wherein
each R independently represents a monovalent group selected from the group consisting of alkyl groups, vinyl groups, higher alkenyl groups, cycloalkyl groups, aryl groups, and fluorine-containing groups;
each Z independently represents a divalent group selected from the group consisting of arylene groups, alkarylene groups, aralkylene groups, alkylene groups, and cycloalkylene groups, and combinations thereof.
each Y independently represents a divalent group selected from the group consisting of alkylene groups, alkarylene groups, aralkylene groups, arylene groups, and combinations thereof;
each D is independently selected from the group consisting of hydrogen, alkyl groups having 1 to 10 carbon atoms, phenyl, and groups that complete a ring structure including B or Y to form a heterocycle;
each B independently represents a divalent group selected from the group consisting of alkylene groups, alkarylene groups, aralkylene groups, cycloalkylene groups, arylene groups, and poly(alkyleneoxy) groups, and combinations thereof;
p is an integer number that is at least 10;
n is an integer that is at least 1; and
m is an integer in a range of from at least 1 up to and including 1,000, and wherein the ratio of n to m is in a range of from about 1:10 to about 10:1.

8. The adhesive composition of claim 7, wherein 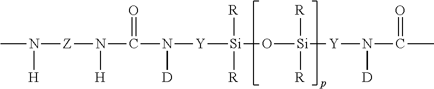
has a formula weight of 10,000 to about 40,000 grams per mole.

9. The adhesive composition of claim 7 or 8, wherein R is methyl, Z is —CH₂C₆H₄C(CH₃)₂C₆H₄CH₂—, Y is —CH₂CH₂CH₂—, D is H, and B is —CH₂CH₂CH₂CH(CH₃)—.

10-11. (canceled)

12. The adhesive composition of claim 1, wherein the elastomeric silicone-based copolymer comprises an amide-based silicone copolymer comprising at least two repeat units of the formula: 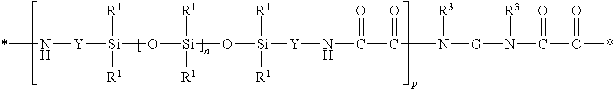
wherein each R¹ is independently an alkyl, haloalkyl, aralkyl, alkenyl, aryl, or aryl substituted with an alkyl, alkoxy, or halo;
each Y is independently an alkylene, aralkylene, or a combination thereof;
G is a divalent residue equal to a diamine of formula R³HN-G-NHR³ minus the two —NHR³ groups;
R³ is hydrogen or alkyl or R³ taken together with G and to the nitrogen to which they are both attached form a heterocyclic group;
n is independently an integer of 0 to 1500; and
p is an integer of 1 to 10.

13. The adhesive composition of claim 1, wherein the adhesive composition is a pressure-sensitive adhesive.

14. The adhesive composition of claim 13, wherein the pressure sensitive adhesive is optically clear.

15. An adhesive article comprising the pressure sensitive adhesive of claim 1, applied to at least one major surface of a substrate.

16-19. (canceled)

20. The adhesive article of claim 15, wherein the adhesive article has a visible light transmission of at least about 90%, and a haze of no greater than 5%.

21. The adhesive article of claim 15, wherein the adhesive article is extensible, and is stretch releasable.

22. The adhesive article of claim 15, further comprising additional extensible layers.

23. The adhesive article of claim 15, wherein the pressure-sensitive adhesive layer has a thickness from about 25 micrometers to about 300 micrometers

24. The adhesive article of claim 15, wherein the pressure-sensitive adhesive comprises at least one structured surface.

25. The adhesive article of claim 15, wherein the adhesive article further comprises at least one layer comprising a foam.

26. The adhesive article of claim 15, wherein the adhesive article exhibits a 180° PEEL ADHESION to a glass substrate no greater than about 500 N/dm after aging for seven days at 85° C.

27-32. (canceled)
